(19) United States
(12) Patent Application Publication
(10) Pub. No.: US 2014/0078423 A1
(43) Pub. Date: Mar. 20, 2014

(54) LIQUID CRYSTAL ELEMENT AND DISPLAY DEVICE

(71) Applicants: Hidehiko Suzuki, Osaka-shi (JP); Kazuhide Akita, Osaka-shi (JP); Takehiko Kawamura, Osaka-shi (JP); Hiroyuki Sone, Osaka-shi (JP); Nobuhiro Waka, Osaka-shi (JP); Tohru Shirai, Osaka-shi (JP); Yuichi Sonoyama, Yonago-shi (JP)

(72) Inventors: Hidehiko Suzuki, Osaka-shi (JP); Kazuhide Akita, Osaka-shi (JP); Takehiko Kawamura, Osaka-shi (JP); Hiroyuki Sone, Osaka-shi (JP); Nobuhiro Waka, Osaka-shi (JP); Tohru Shirai, Osaka-shi (JP); Yuichi Sonoyama, Yonago-shi (JP)

(73) Assignee: SHARP KABUSHIKI KAISHA, Osaka-shi, Osaka (JP)

(21) Appl. No.: 14/118,246

(22) PCT Filed: Mar. 18, 2012
(86) PCT No.: PCT/JP2012/062747

§ 371 Date: Nov. 18, 2013

(30) Foreign Application Priority Data
May 25, 2011 (JP) 2011-116977

(51) Int. Cl. G02F 1/1339; G02B 27/22

(52) U.S. Cl. CPC G02F 1/1339; G02B 27/2214
USPC 349/12; 349/155; 349/15

(57) ABSTRACT

A liquid crystal panel (a liquid crystal element) 12 according to the present invention includes a pair of substrates 12a and 12b having a normal distance therebetween, a liquid crystal layer 27 arranged between the substrates 12a and 12b, a plurality of first spacers 34, and a plurality of second spacers 35. The first spacers 34 have an average particle diameter AD1 that is larger than the normal distance SD between the substrates 12a and 12b and are configured to define a distance between the substrates 12a and 12b. The second spacers 35 have an average particle diameter AD2 that is smaller than the normal distance SD between the substrates 12a and 12b and are configured to define the distance between the substrates 12a and 12b.

### TECHNICAL FIELD

The present invention relates to a liquid crystal element and a display device.

### BACKGROUND ART

A liquid crystal panel is a component of a liquid crystal display device. Such a liquid crystal panel mainly includes a pair of substrates that are arranged facing each other with a predetermined distance therebetween and a liquid crystal layer and spacers that maintain the distance between the substrates. A periphery of the substrates is sealed with a sealing agent.

### RELATED ART DOCUMENT

### Patent Document

Patent Document 1: Japanese Unexamined Patent Publication No. 62-150223

### Problem to be Solved by the Invention

If the environment in which a liquid crystal display panel is used changes from a normal temperature environment to a low temperature environment, volume shrinkage occurs in the liquid crystal layer between the pair of the substrates. If each spacer has an excessive defining force that defines the distance between the substrates, the distance between the substrates does not decrease according to the volume shrinkage of the liquid crystal layer. This may cause vacuum bubbles. On the other hand, if the defining force of the spacers are reduced by, for example, decreasing the number thereof, the spacers may fail to resist an external stress applied to at least one of the substrates and may be excessively deformed. This may damage or break the spacers and may degrade pressure resistance.

### DISCLOSURE OF THE PRESENT INVENTION

The present invention was made in view of the above circumstances, and an object of the present invention is to obtain sufficient pressure resistance with less occurrence of low temperature bubbles.

### Means for Solving the Problem

A liquid crystal element according to the present invention includes a pair of substrates, a liquid crystal layer, a plurality of first spacers, and a plurality of second spacers. The pair of substrates has a normal distance therebetween. The liquid crystal layer is arranged between the substrates. The first spacers have an average particle diameter that is larger than the normal distance between the substrates and are configured to define a distance between the substrates. The second spacers have an average particle diameter that is smaller than the normal distance between the substrates and are configured to define the distance between the substrates.

In this configuration, the average particle diameter of the first spacers is relatively larger than the normal distance between the substrates. Thus, the first spacers almost always define the distance between the substrates in a deformed state. The “normal distance between the substrates” is the distance between the substrates in a normal temperature environment (for example, temperatures of the environment is in a range of 5 to 35° C.) with no external stresses applied to any one of the substrates.

In contrast, the average particle diameter of the second spacer is smaller than the normal distance between the substrates. Thus, the second spacers do not define the distance between the substrates until an external stress is applied to the substrates in the normal temperature environment. If the environment is changed from the normal temperature environment to a low temperature environment (for example, temperature less than 5° C.) and volume shrinkage occurs in the liquid crystal layer, the distance between the substrates may decrease to be smaller than the normal distance. In this case, although the first spacers are further deformed from the state that is in the normal temperature environment, the second spacers are hardly deformed until the distance between the substrates reaches the average particle diameter of the second spacers. This allows the distance between the substrates to easily decrease according to the volume shrinkage of the liquid crystal layer and thus the vacuum bubbles are less likely to be generated. In the normal temperature environment, the second spacers in addition to the first spacers define the distance between the substrates when an external stress is applied to at least one of the substrates and the distance between the substrates decreases from the normal distance and reaches the average particle diameter of the second spacers. Therefore, the first spacers are less likely to be excessively deformed and damaged or broken. As a result, sufficiently high pressure resistance can be obtained.

The following configuration may be preferable as embodiments of the present invention.

(1) The average particle diameter of the second spacers may be in a range of 80 to 95% of the average particle diameter of the first spacers. If the average particle diameter of the second spacers is smaller than 80% of the average particle diameter of the first spacers, the first spacer may be excessively deformed by an external stress that is applied to at least one of the substrates. This may cause damage or breakage of the first spacer. As a result, sufficient pressure resistance may not be obtained. In contrast, if the average particle diameter of the second spacers is larger than 95% of the average particle diameter of the first spacers, that is, the difference between the average particle diameters of the first spacers and the second spacers is quite small, the distance between the substrates hardly decreases according to the volume shrinkage of the liquid crystal layer in the low temperature environment. This may result in generating low temperature bubbles. However, as described above, the average particle diameter of the second spacers that is in a range of 80 to 95% of the average particle diameter of the first spacers is suitable to reduce occurrence of the low temperature bubbles while obtaining pressure resistance.

(2) Each of the second spacers may include an adhering layer that is configured to be adhered to at least one of the substrates. Since the average particle diameter of the second spacers is relatively smaller than the normal distance of the substrates, the second spacers tend to move around compared to the first spacers that are sandwiched and deformed by the substrates in the normal temperature environment. With the adhering layer, the second spacers are firmly attached to at least one of the substrates and less likely to move around and gather one another.

(3) The number of first spacers may be relatively smaller than the number of second spacers. With this configuration, the distance between the substrates easily decreases corresponding to the volume shrinkage in the liquid crystal layer compared to a case in which the number of first spacers is equal to or relatively larger than the number of the second spacers. Thus, vacuum bubbles are less likely to be generated. In addition, if an external stress is applied to at least any one of the substrates, the second spacers that are arranged more than the first spacers properly define the distance between the substrates. Therefore, the first spacers are less likely to be excessively deformed and less likely to have damage or breakage.

(4) A parallax barrier pattern may be arranged on a plate surface of at least one of the substrates. With this configuration, an image seen by a viewer through the liquid crystal element is separated by the parallax barrier pattern, and thus the viewer can recognize a stereoscopic image.

(5) The parallax barrier pattern may include a pair of transparent electrodes arranged on a plate surface of each of the substrates so as to face each other. The plate surface of each substrate faces the liquid crystal layer. The transparent electrodes may be configured to provide a plurality of barrier sections and a barrier opening provided between the barrier sections by controlling a voltage value between the transparent electrodes. The barrier sections are configured to block light and the barrier opening is configured to allow the light to pass therethrough. With this configuration in which the barrier sections and the barrier openings are provided, an image is seen at a specific viewing angle through the barrier openings arranged between the barrier sections via the liquid crystal element. This enables the image to be separated by parallax. In addition, the voltages between the transparent electrodes are controlled to selectively form the barrier sections and the barrier opening. This enables the switching between the stereoscopic image display and a flat image display.

(6) A touch panel pattern may be arranged on another plate surface of one of the substrates. The other plate surface may face a side opposite to the liquid crystal layer. The touch panel pattern may be configured to detect a position input by a user. With this configuration, the position touched by the user can be detected by the touch panel pattern. Such a substrate, on which the touch panel pattern is arranged, frequently receives external stresses and those stresses tend to be strong. However, the liquid crystal element according to the present invention is effective to the above configuration because the first spacers and the second spacers that define the distance between the substrates ensure high pressure resistance.

To solve above problem, a display device according to the present invention may include the above-described liquid crystal element and a display element stacked on the liquid crystal element and configured to display an image.

According to the display device, the liquid crystal element stacked on the display element to display an image has both advantages of reducing low temperature bubbles and having pressure resistance. Therefore, the liquid crystal element has high display quality and an enhanced product lifetime.

The following configuration may be preferable as embodiments of the present invention.

(1) The liquid crystal element may include a parallax barrier pattern configured to separate an image displayed on the display element by parallax. With this configuration, the image displayed on the display element that is seen by a viewer via the liquid crystal element is separated by the parallax barrier pattern. Thus, the viewer of the display device can recognize the stereoscopic image.

(2) The liquid crystal element may be arranged on a side closer to a viewer than the display element. The liquid crystal element arranged closer to the viewer side than the display element easily receives an external stress, for example, a stress touched by a viewer. However, the liquid crystal element according to the present invention is suitable for the above configuration because the first spacers and the second spacers that define the distance between the substrates ensure high pressure resistance.

(3) The display device may include a lighting device configured to apply light to the display element. With this configuration, the display element displays an image using the light applied from the lighting device.

### Advantageous Effect of the Invention

According to the present invention, sufficient pressure resistance is obtained with less occurrence of low temperature bubbles.

### BRIEF DESCRIPTION OF THE DRAWINGS

FIG. 1 is a cross-sectional view illustrating a general configuration of a liquid crystal display device according to a first embodiment of the present invention.

FIG. 2 is a plan view of the liquid crystal display device.

FIG. 3 is a cross-sectional view of a liquid crystal display panel and a liquid crystal panel.

FIG. 4 is a plan view illustrating the liquid crystal display panel to which a flexible printed board for display is connected.

FIG. 5 is a plan view illustrating an arrangement of pixel electrodes and lines on an array substrate included in the liquid crystal display panel.

FIG. 6 is a plan view illustrating an arrangement of color sections on a CF substrate included in the liquid crystal display panel.

FIG. 7 is a cross-sectional view of a display area of the liquid crystal display panel.

FIG. 8 is a plan view of the liquid crystal panel to which a flexible printed board for panel is connected.

FIG. 9 is a plan view of a first substrate included in the liquid crystal panel.

FIG. 10 is a bottom view of a second substrate included in the liquid crystal panel.

FIG. 11 is a cross-sectional view of a display overlapping area of the liquid crystal panel.

FIG. 12 is an explanatory view schematically illustrating a relationship among eyes of a user, barrier sections and barrier openings of a parallax barrier, and pixels for right eye and pixels for left eye.

FIG. 13 is a graph schematically indicating particle size distributions of first spacers and second spacers.

FIG. 14 is a cross-sectional view illustrating a manufacturing process of the liquid crystal panel in which the second substrate is to be attached to the first substrate on which the first spacers and the second spacers are arranged.

FIG. 15 is a cross-sectional view illustrating a cross-sectional configuration of the display overlapping area of the liquid crystal panel that is under a low temperature environment or that receives external pressure force.

FIG. 16 is a cross-sectional view of a liquid crystal display panel and a liquid crystal panel of a second embodiment.

FIG. 17 is a plan view illustrating a second substrate included in the liquid crystal panel.

FIG. 18 is a plan view illustrating a plan arrangement of a touch panel pattern.

FIG. 19 is a cross-sectional view taken along a line xix-xix in FIG. 18.

FIG. 20 is a cross-sectional view taken along a line xx-xx in FIG. 18.

### MODE FOR CARRYING OUT THE INVENTION

### First Embodiment

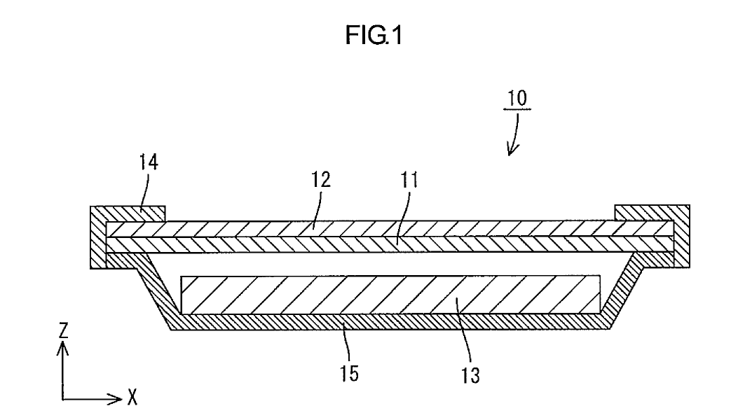

A first embodiment of the present invention will be described with reference to FIG. 1 to FIG. 15. In the first embodiment, a liquid crystal display device (a display device) 10 including a liquid crystal panel (liquid crystal element) 12 having a parallax barrier function will be described as an example. An X-axis, a Y-axis, and a Z-axis are described in some of the drawings, and a direction of each axis corresponds to the direction described in each drawing. An upper and lower direction is described based on FIG. 1. In addition, the upper side in FIG. 1 corresponds to a front side, and the lower side therein corresponds to a rear side.

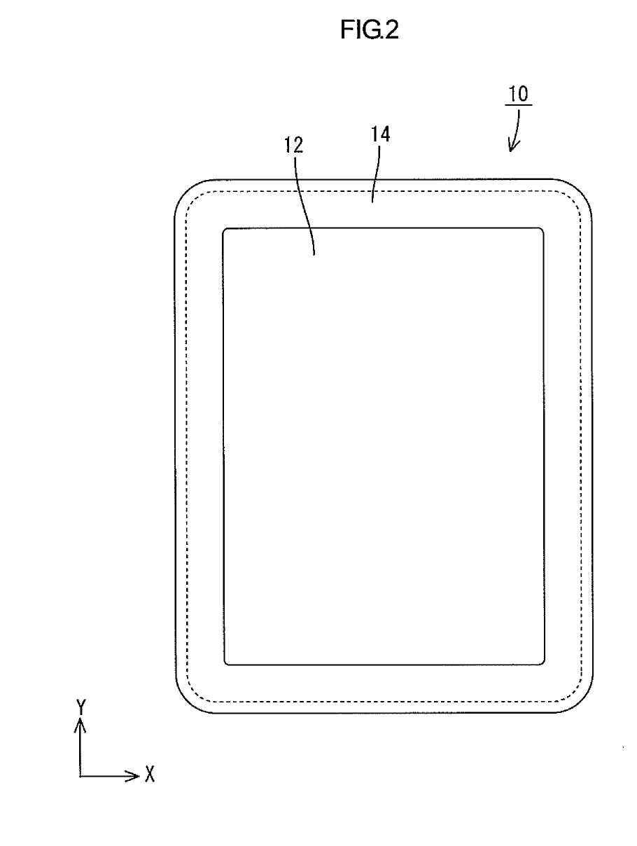

A configuration of the liquid crystal display device 10 is described. As illustrated in FIG. 1 and FIG. 2, the liquid crystal display device 10 has a rectangular shape as a whole in a plan view. The liquid crystal display device 10 may be placed in a portrait orientation (in a vertical position) or a landscape orientation (in a horizontal position). The liquid crystal display device 10 includes a liquid crystal display panel (a display element) 11 configured to display an image, the liquid crystal panel 12 having a parallax barrier function, and a backlight unit (a lighting device) 13 as an external lighting source. The backlight unit 13 is configured to emit light toward the liquid crystal display panel 11 and the liquid crystal panel 12. The liquid crystal display device 10 further includes a bezel 14 and a housing 15. The bezel 14 holds the liquid crystal display panel 11 and the liquid crystal panel 12 and attached to the housing 15. The housing 15 houses the backlight unit 12.

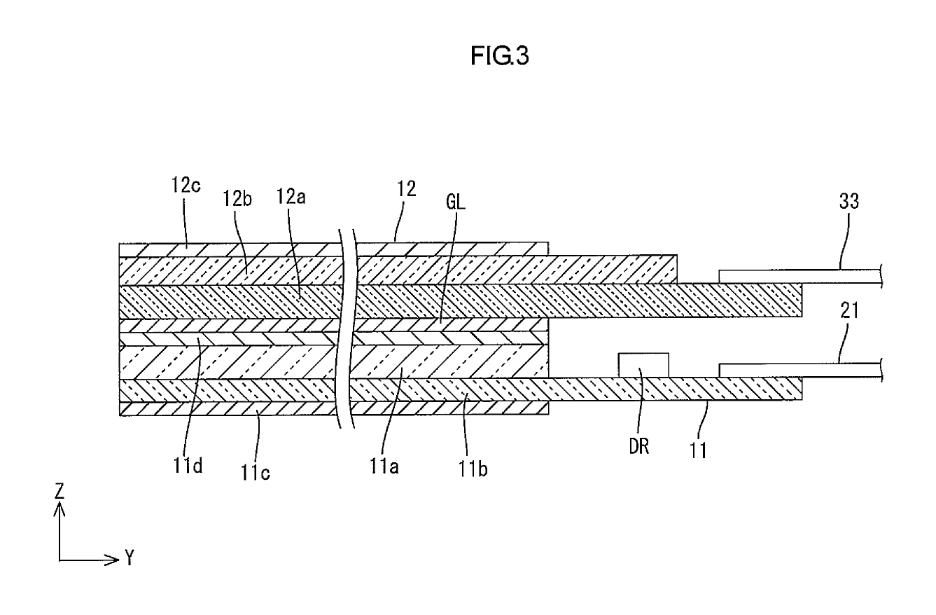

As illustrated in FIG. 3, the liquid crystal display panel 11 and the liquid crystal panel 12 are arranged such that main surfaces thereof face each other. The liquid crystal panel 12 is arranged on a front side (a light emitting side, a viewer side), and the liquid crystal display panel 11 is arranged on a rear side (a side closer to the backlight unit 13, a side opposite to the light emitting side). The liquid crystal display panel 11 and the liquid crystal panel 12 are connected to each other with a photo curable adhesive GL therebetween. The photo curable adhesive GL is made of a photo curable resin material that is almost transparent and has high light transmissivity. The photo curable resin material is cured by light having a specific wavelength range such as ultra violet rays (UV rays). The liquid crystal display device 10 of the present embodiment is used in various electronic devices (not illustrated) such as a handheld terminal (including an e-book and PDA), a mobile phone (including a smart phone), a laptop computer, a digital photo frame, and a handheld gaming device. Accordingly, the liquid crystal display panel 11 included in the liquid crystal display device 10 has a display size within a range of a few inches, for example, 3.4 inches, to about 10 inches. That is, the liquid crystal display panel 11 has a compact size or a small-medium size.

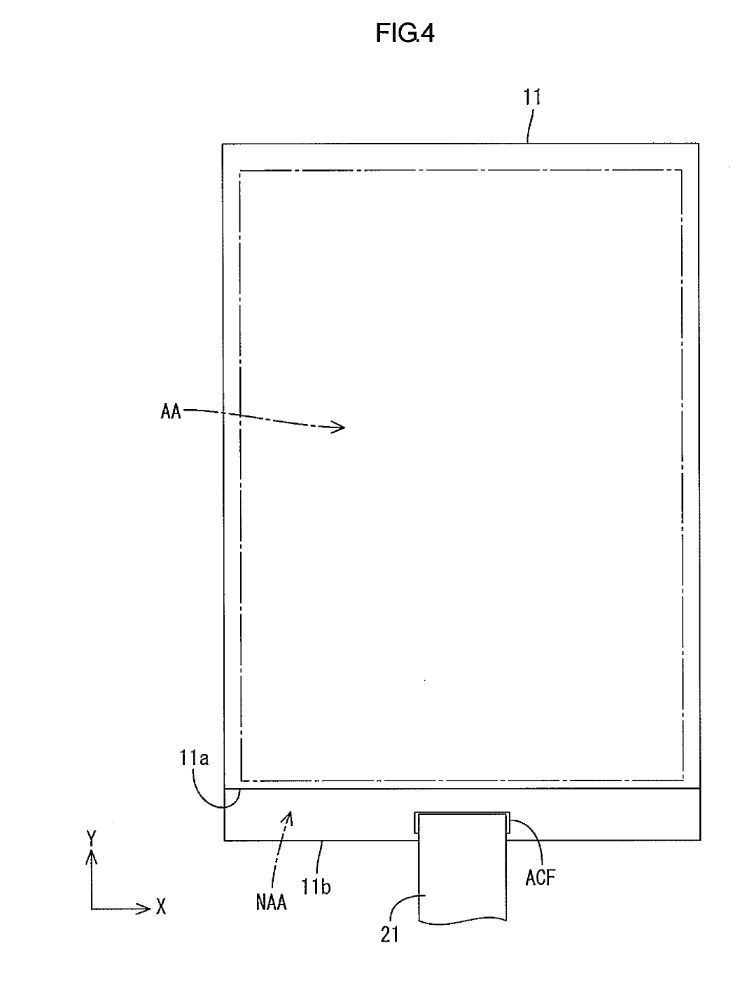

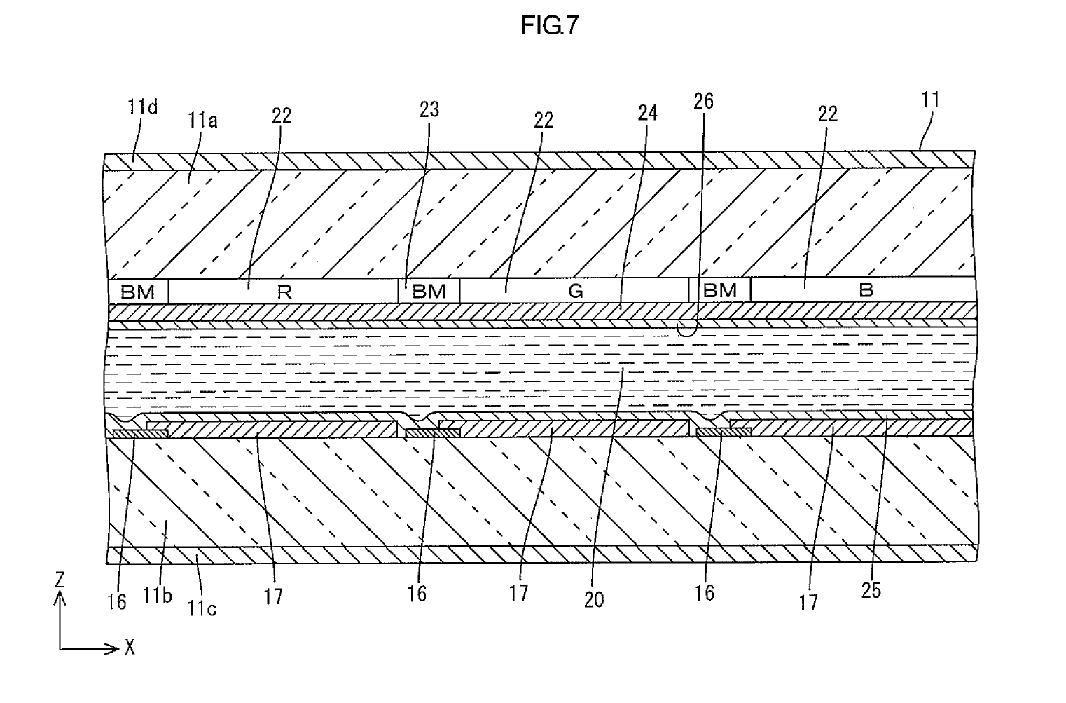

Next, the liquid crystal display panel 11 is described. As illustrated in FIG. 3, FIG. 4, and FIG. 7, the liquid crystal display panel 11 includes a pair of transparent rectangular glass substrates 11a and 11b (having light transmissivity) and a liquid crystal layer 20 provided therebetween. The liquid crystal layer 20 includes liquid crystals having optical characteristics that vary according to electric fields applied thereto. The substrates 11a and 11b are bonded together with sealant, which is not illustrated, leaving a distance (a cell thickness, a gap) corresponding to a thickness of the liquid crystal layer 20 therebetween. The liquid crystal display panel 11 includes a spacer, which is not illustrated, configured to define a distance between the substrates 11a and 11b. As illustrated in FIG. 4, the liquid crystal display panel 11 further includes a display area AA (an area enclosed by one dotted chain line in FIG. 4) in which an image is displayed and a non-display area NAA in which an image is not displayed. The non-display area NAA has a frame-like shape and surrounds the display area AA. As illustrated in FIG. 3, polarizing plates 11c and 11d are each attached to an outer surface side of the substrates 11a and 11b. The above-described photo curable adhesive GL is provided over a substantially entire surface of an outer surface of a front side polarizing plate 11d (on a liquid crystal panel 12 side) of the front and rear polarizing plates 11c and 11d. As illustrated in FIG. 2, if the liquid crystal display panel 11 is placed in a portrait orientation, a long-side direction (a Y-axis direction) thereof matches a vertical direction in a viewer's view (the upper and lower direction) and a short-side direction (an X-axis direction) thereof matches a horizontal direction in a viewer's view (a right-left direction, a direction along eyes LE and RE). If the liquid crystal display panel 11 is placed in a landscape orientation, a long-side direction thereof matches the horizontal direction of in a viewer's view and a short-side direction thereof matches the vertical direction in a viewer's view.

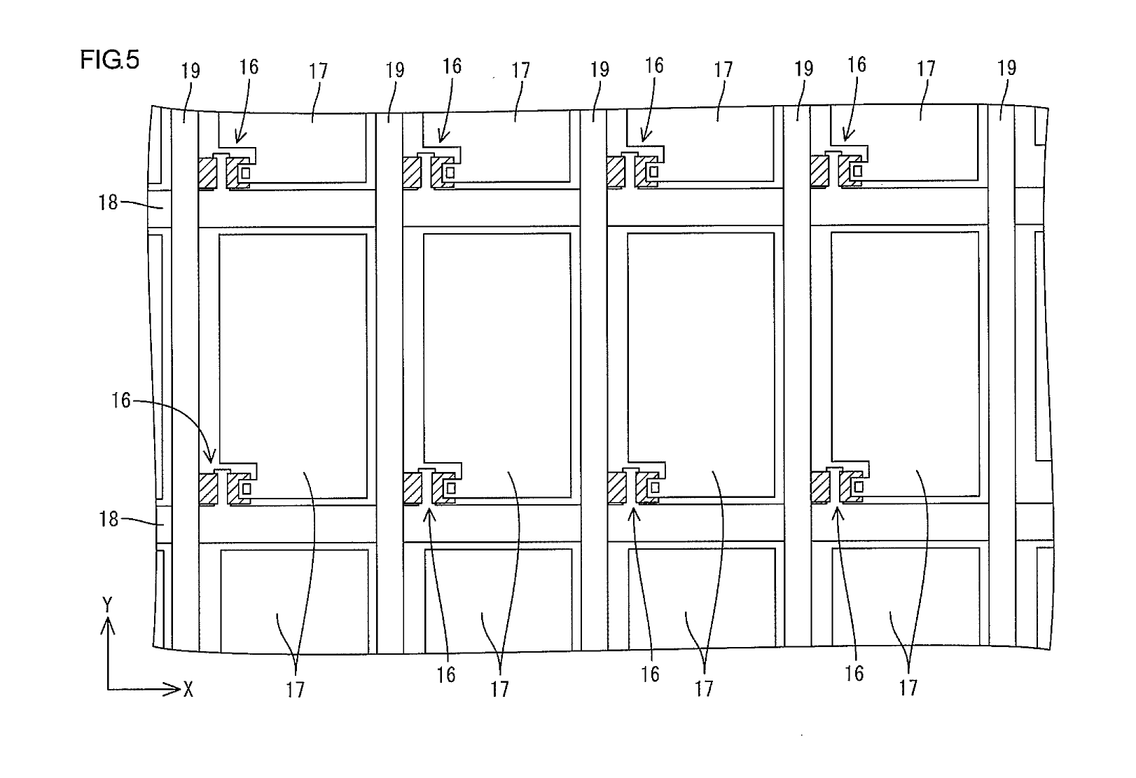

One of the substrates 11a and 11b that is on the front side is a CF substrate 11a and the other one that is on the rear side is an array substrate 11b. As illustrated in FIG. 5 and FIG. 7, TFTs 16 (Thin Film Transistor) as switching components and pixel electrodes 17 are arranged in a matrix in the display area AA in an inner surface side (the liquid crystal layer 20 side, a side facing the CF substrate 11a) of the array substrate 11b. Around the TFTs 16 and the pixel electrodes 17, gate lines 18 and source lines 19 are arranged in a grid so as to surround the TFTs 16 and the pixel electrodes 17. The pixel electrodes 17 are made of a substantially transparent and light transmissive conductive material such as ITO (indium tin oxide). The gate lines 18 and the source lines 19 are made of light shielding metal such as copper or titanium. The gate lines 18 and the source lines 19 are connected to gate electrodes and source electrodes of the TFTs 16, respectively. The pixel electrodes 17 are connected to drain electrodes of the TFTs 16. As illustrated in FIG. 4, the gate lines 18 and the source lines 19 extend to the non-display area NAA of the inner surface of the array substrate 11b, and ends thereof are connected to a driver DR for driving liquid crystals. The driver DR is mounted on an end portion of the array substrate 11b in the long-side direction with a chip on glass method (COG). The driver DR is configured to supply a drive signal to the lines 18 and 19 connected to the driver DR. At a position adjacent to the driver DR on the inner surface of the array substrate 11b (in the non-display area NAA), one end of a flexible printed board for display 21 is connected with pressure via an anisotropic conductive film ACF. The other end of the flexible printed board for display 21 is connected to a control board (not illustrated). This allows the image signal supplied from the control board to be transmitted to the driver DR.

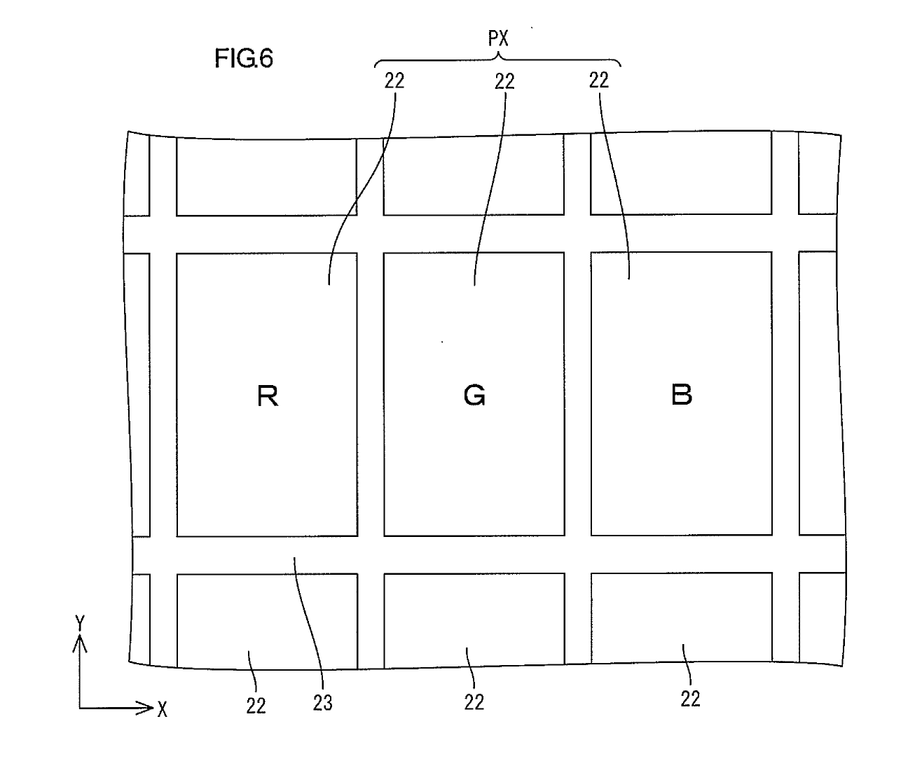

On an inner surface side (the liquid crystal layer 20 side, a surface facing the array substrate 11b) of the CF substrate 11a, as illustrated in FIG. 6 and FIG. 7, color filters are arranged at positions overlapping with the pixel electrodes 17 on the array substrate 11b in a plan view. The color filters include red (R), green (G), and blue (B) color sections 22 that are alternately arranged in the X-axis direction. Each of the color sections 22 has a rectangular shape in a plan view. A long-side direction and a short-side direction of the color section 22 match the long-side direction and the short-side direction of the substrate 11a and 11b, respectively. The color sections 22 are arranged in the X-axis direction and the Y-axis direction on the CF substrate 11a in a matrix. A grid-like light blocking section (a black matrix) 23 that prevents color mixing is provided between the color sections 22 included in the color filter. The light blocking section 23 is arranged to overlap with the gate lines 18 and the source lines 19 on the array substrate 11b. The color sections 22 of R, G, and B and three pixel electrodes 17 corresponding thereto configure one pixel PX in the liquid crystal display panel 11. The pixels PX are arranged in a matrix along a main surface, i.e., the display surface (the X-axis direction and the Y-axis direction) of the substrates 11a and 11b. As illustrated in FIG. 7, counter electrodes 24 are arranged on front surfaces of the color sections 22 and the light blocking sections 23 so as to face the pixel electrodes 17 on the array substrate 11b. Alignment films 25 and 26 are arranged on the inner surface side of each of the substrates 11a and 11b to align the liquid crystal molecules in the liquid crystal layer 20.

The backlight unit 13 is briefly described first, and then the liquid crystal panel 12 is described. The backlight unit 13 is an edge-light type (a side-light type) backlight unit. The backlight unit 13 includes light sources, a box-like chassis, a light guiding member, and an optical member. The light sources are arranged to face ends of the light guiding member. The chassis has an opening that opens toward the front side (the liquid crystal display panel 11 side, the light exiting side) and houses the light sources. The light guiding member is configured to guide light from the light sources to the opening (a light exiting portion) of the chassis. The optical member is arranged to cover the opening of the chassis. The light emitted from the light sources enters the ends of the light guiding member and travels through the light guiding member to exit from the opening of the chassis. Then, the optical member converts the light into a planar light having an even luminance distribution and the light is applied to the liquid crystal display panel 11. Light transmissivity is selectively changed in the display surface of the liquid crystal display panel 11 by the driving of TFTs 16 included in the liquid crystal display panel 11, and thus a predetermined image is displayed in the display surface. The light sources, the chassis, the light guiding member, and the optical member are not illustrated in detail.

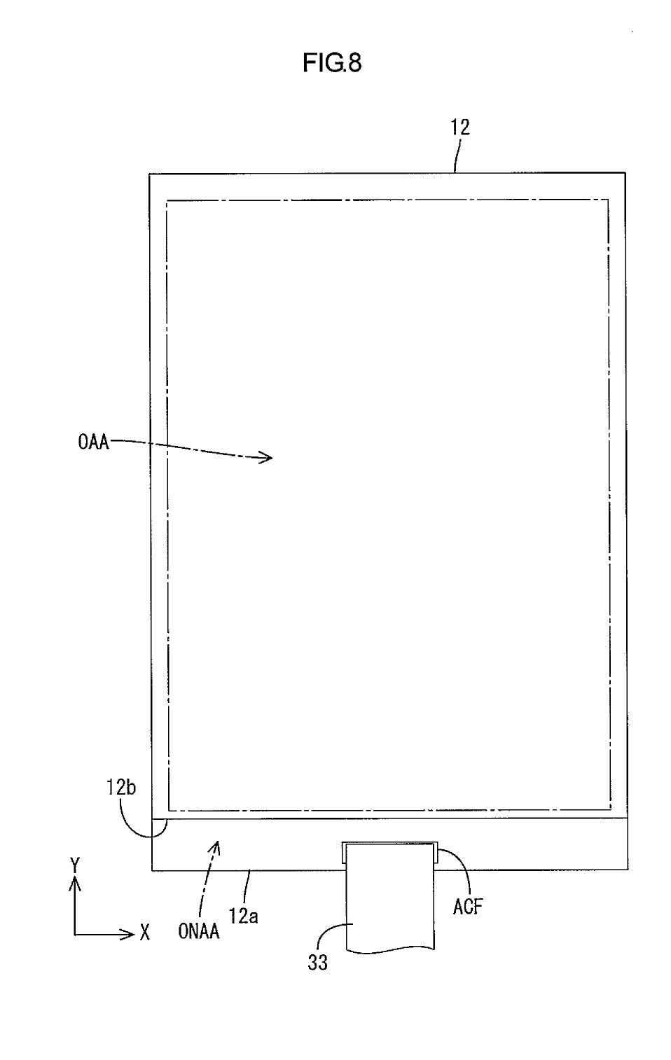

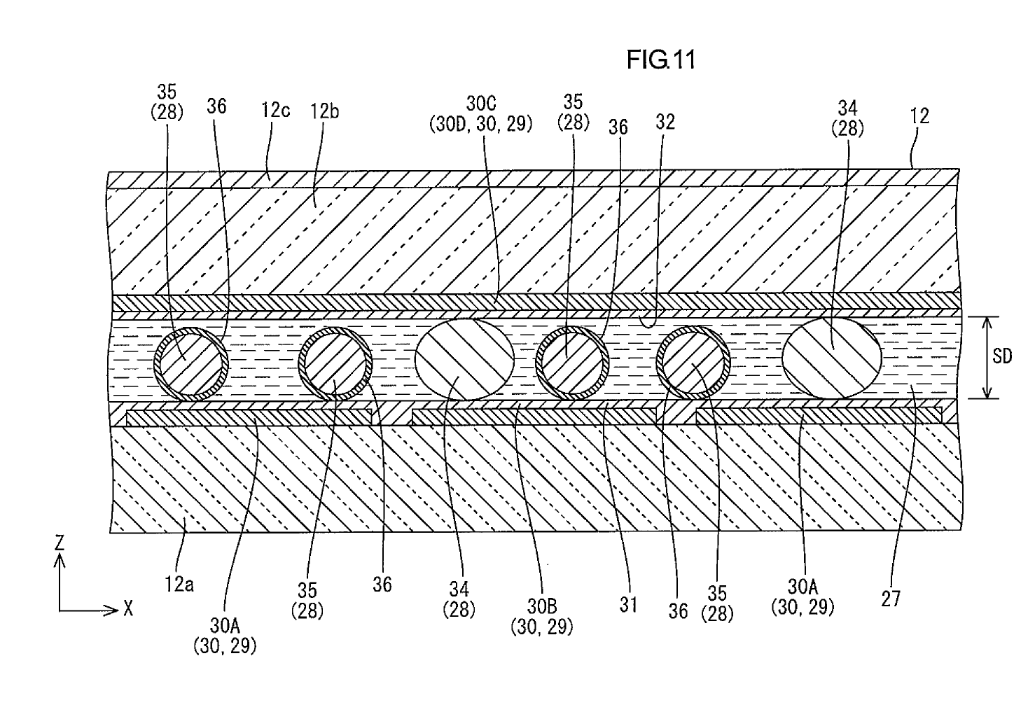

Then, the liquid crystal panel 12 is described in detail. As illustrated in FIG. 3, FIG. 8, and FIG. 11, the liquid crystal panel 12 includes a pair of glass substrates 12a and 12b and a liquid crystal layer 27 provided and sandwiched therebetween. The glass substrates 12a and 12b each have a rectangular shape in a plan view and are transparent (having light transmissive properties). The liquid crystal layer 27 includes liquid crystal molecules having optical characteristics that vary according to electric fields applied thereto. The substrates 12a and 12b are bonded together with sealant, which is not illustrated, with a distance (a cell thickness, a gap) corresponding to a thickness of the liquid crystal layer 27 therebetween. The liquid crystal panel 12 further includes spacers 28 configured to define the distance between the substrates 12a and 12b. The spacers 28 will be described in detail later. The liquid crystal panel 12 is a liquid crystal panel. As illustrated in FIG. 8, the liquid crystal panel 12 includes a display overlapping area OAA (an area surrounded by a one dotted chain line in FIG. 8) that overlaps with the display area AA of the liquid crystal display panel 11 in a plan view and a display non-overlapping area ONAA that overlaps with the non-display area NAA of the liquid crystal display panel 11. The display non-overlapping area ONAA has a frame-like shape and surrounds the display overlapping area OAA. The above described sealant is applied to the display non-overlapping area ONAA so as to be in a frame-like shape corresponding to the display non-overlapping area ONAA in a plan view. A predetermined amount of the above described spacers 28 are dispersed in an area surrounded by the sealant (including an entire area of the display overlapping area OAA and an inner peripheral area of the display non-overlapping area ONAA).

As illustrated in FIG. 3, the liquid crystal panel 12 has a screen size substantially the same as that of the liquid crystal display panel 11 and is attached in parallel to the liquid crystal display panel 11 with the photo curable adhesive GL. If the liquid crystal panel 12 is placed in a portrait orientation, a long-side direction (a Y-axis direction) of the liquid crystal panel 12 matches a vertical direction in a viewer's view (the upper and lower direction) and a short-side direction (an X-axis direction) thereof matches a horizontal direction in a viewer's view (a right-left direction, a direction along eyes LE, RE). If the liquid crystal panel 12 is placed in a landscape orientation, a long-side direction of the liquid crystal panel 12 matches the horizontal direction in a viewer's view and a short-side direction thereof matches the vertical direction in a viewer's view. As illustrated in FIG. 8, the substrates 12a and 12b included in the liquid crystal panel 12 have short sides (dimension in the X-axis direction) equal to each other. A first substrate 12a on the rear side (the liquid crystal display panel 11 side) has long sides (dimension in the Y-axis direction) longer than those of a second substrate 12b on the front side. The long sides of the first substrate 12a have substantially equal length with the long sides of the array substrate 11b of the liquid crystal display panel 11. The second substrate 12b on the front side has long sides longer than those of the CF substrate 11a of the liquid crystal display panel 11. As illustrated in FIG. 3, the photo curable adhesive GL described above is applied on an outer surface of the first substrate 12a facing the rear side (a plate surface facing the liquid crystal layer 27 side), i.e., a surface opposing to the liquid crystal display panel 11. A polarizing plate 12c is attached to an outer surface (a plate surface away from the liquid crystal layer 27 side) of the second substrate 12b facing the front side.

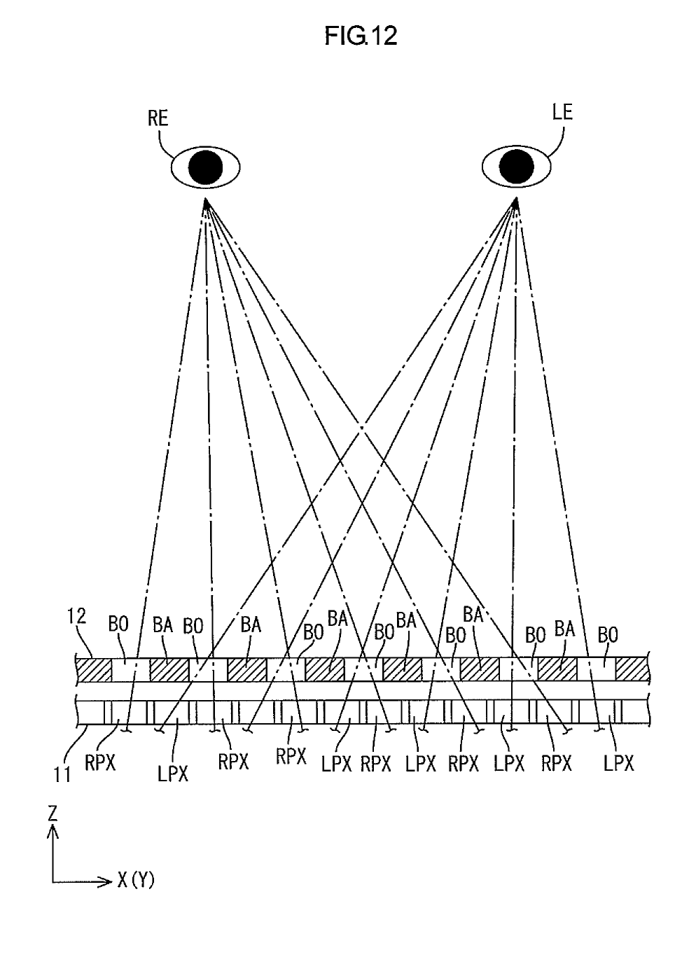

The liquid crystal panel 12 includes a parallax barrier pattern 29 and is configured to be a parallax barrier panel. The parallax barrier pattern 29 separates an image to be displayed in the display surface of the liquid crystal display panel 11 by parallax and allows a viewer to recognize the image as a stereoscopic image (3D image, three-dimensional image). The parallax barrier pattern 29 included in the liquid crystal panel 12 is configured to apply predetermined voltages to the liquid crystal layer 27. According to the voltage applied to the liquid crystal layer 27, an alignment of the liquid crystal molecules and light transmissivity of the liquid crystal layer 27 are controlled and barrier sections BA, which will be described in detail later, are provided. The barrier sections BA separate the image on the pixels PX of the liquid crystal display panel 11 by parallax, and thus the viewer can see the stereoscopic image (see FIG. 12). In other words, the liquid crystal panel 12 is a switching liquid crystal panel that switches between a flat image (the 2D image, the two-dimensional image) and a stereoscopic image (the 3D image, the three-dimensional image) by active control of the light transmissivity of the liquid crystal layer 27 to display the flat image or the stereoscopic image in the display surface of the liquid crystal display panel 11.

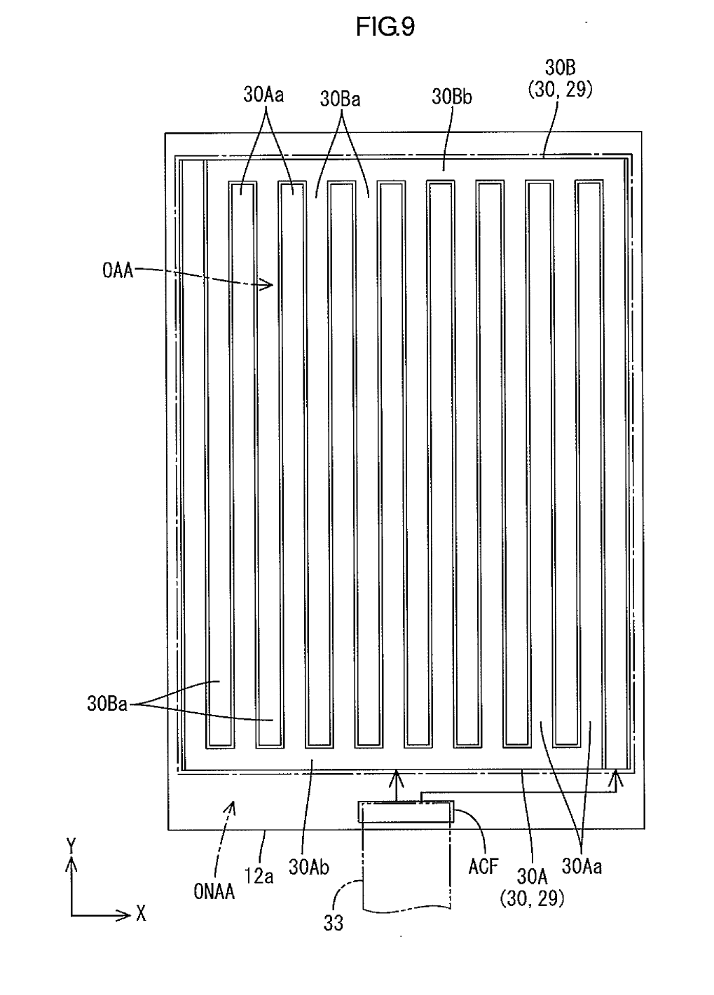

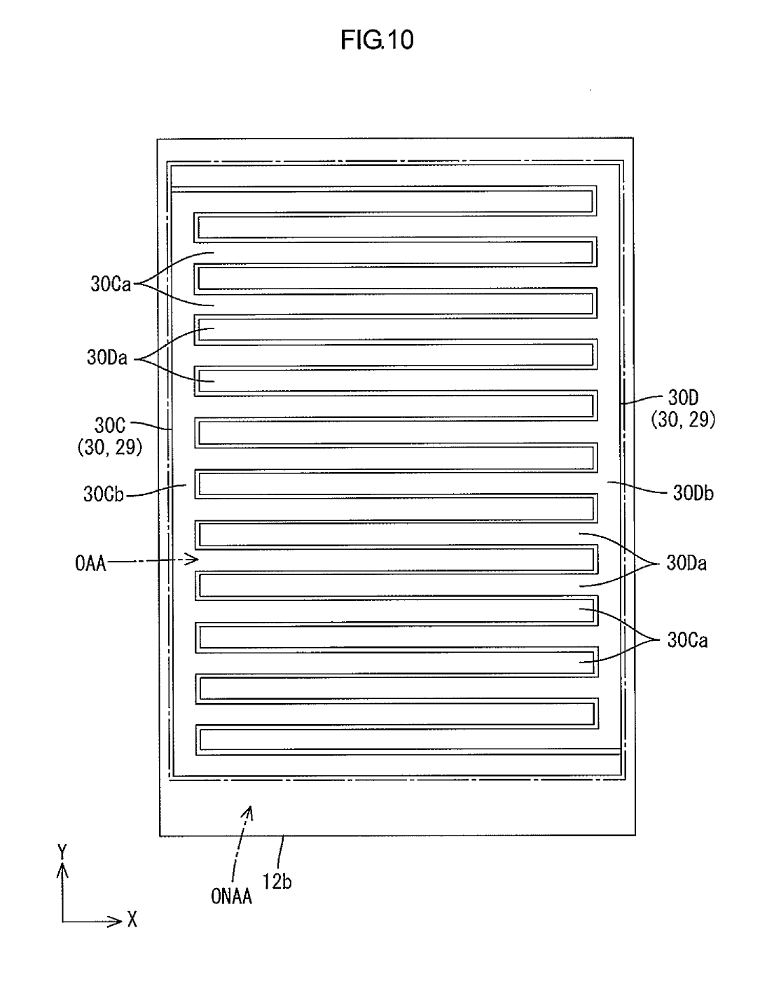

As illustrated in FIG. 9 and FIG. 10, transparent electrodes 30 that constitute the parallax barrier pattern 29 are provided on inner surfaces (a plate surface on a liquid crystal layer 27 side) of the substrates 12a and 12b included in the liquid crystal panel 12 so as to face each other. Like the pixel electrode 17 of the liquid crystal display panel 11, the transparent electrodes 30 are made of a light transmissive conductive material that is almost transparent such as ITO. The transparent electrodes 30 are arranged in the display overlapping area OAA of the liquid crystal panel 12. With this configuration, the display overlapping area OAA of the liquid crystal panel 12 has high light transmissivity, and light passed through the display area AA of the liquid crystal display panel 11 can pass therethrough with low loss. The transparent electrodes 30 are provided in a pair on each of the first substrate 12a that is on the rear side and the second substrate 12b that is on the front side. The transparent electrodes 30 on the first substrate 12a are referred to as a first transparent electrode 30A and a second transparent electrode 30B. The transparent electrodes 30 on the second substrate 12b are referred to as a third transparent electrode 30C and a fourth transparent electrode 30D.

As illustrated in FIG. 9, the first transparent electrode 30A has a comb-like shape and the second transparent electrode 30B has a comb-like shape engaging the first transparent electrode 30A in a plan view. Specifically, the first transparent electrode 30A includes band-like shape portions 30Aa and a connection portion 30Ab. The second transparent electrode 30B includes band-like shape portions 30Ba and a connection portion 30Bb. The band-like shape portions 30Aa and 30Ba each have a band-like shape (a strip-like shape) having a constant width and extend in the long-side direction of the first substrate 12a (the Y-axis direction). The band-like shape portions 24Aa and 24Ba are arranged in parallel with each other in the short-side direction of the first substrate 12a (the X-axis direction). The connection portions 30Ab and 30Bb extend in the short-side direction (the X-axis direction) and connect ends of the band-like shape portions 24Aa and 24Ba, respectively. In the display overlapping area OAA of the first substrate 12a, the band-like shape portions 30Aa of the first transparent electrode 30A and the band-like shape portions 30Ba of the second transparent electrode 30B are alternately arranged in the short-side direction (the X-axis direction).

As illustrated in FIG. 10, the third transparent electrode 30C has a comb-like shape and the fourth transparent electrode 30D has a comb-like shape engaging the third transparent electrode 30C in a plan view. Specifically, the third transparent electrode 30C includes band-like shape portions 30Ca and a connection portion 30Cb. The fourth transparent electrode 30D includes band-like shape portions 30Da and a connection portion 30Db. The band-like shape portions 30Ca and 30Da each have a band-like shape (a strip-like shape) having a constant width and extend in the short-side direction of the second substrate 12b (the X-axis direction). The band-like shape portions 30Ca and 30Da are arranged in parallel with each other in the long-side direction of the second substrate 12b (the Y-axis direction). The connection portions 30Cb and 30Db extend in the log-side direction (the Y-axis direction) and connect ends of the band-like shape portions 30Ca and 30Da, respectively. In the display overlapping area OAA of the second substrate 12b, the band-like shape portions 30Ca of the third transparent electrode 30C and the band-like shape portions 30Da of the fourth transparent electrode 30D are alternately arranged in the long-side direction (the Y-axis direction). As illustrated in FIG. 11, in the substrates 12a and 12b that are attached to each other, the band-like shape portions 30Ab of the first transparent electrode 30A and the band-like shape portions 30Bb of the second transparent electrode 30B face the band-like shape portions 30Ca of the third transparent electrode 30C and the band-like shape portions 30Da of the fourth transparent electrode 30D with the liquid crystal layer 27 therebetween. The long-side directions of the band-like shape portions 30Aa and 30Ba and the long-side directions of the band-like shape portions 30Ca and 30Da are oriented substantially perpendicular to each other. Alignment films 31 and 32 are provided on the inner surface side of each of the substrates 12a and 12b to align the liquid crystal molecules in the liquid crystal layer 27.

As illustrated in FIG. 9, terminals (not illustrated) extending from the first transparent electrode 30A and the second transparent electrode 30B are located at an end portion of the first substrate 12a in the long-side direction. One end of a panel flexible printed board 33 is connected to the terminals with pressure via an anisotropic conductive film ACF, and the other end of the panel flexible printed board 33 is connected to a control substrate, which is not illustrated. With this configuration, the panel flexible printed board 33 is configured to transmit a barrier driving signal supplied from the control substrate to the first transparent electrode 30A and the second transparent electrode 30B. As illustrated in FIG. 8, the terminals and the panel flexible printed board 33 are arranged in the display non-overlapping area ONAA of the parallax barrier 12. The third transparent electrode 30C and the fourth transparent electrode 30D on the second substrate 12b are electrically connected to the terminals of the first substrate 12a via a conductive pillar (not illustrated) to receive the barrier signal therefrom. The conductive pillar passes through the liquid crystal layer 27 and connects the substrates 12a and 12b. As illustrated in FIG. 8, the second substrate 12b has long sides that are smaller in length than those of the first substrate 12a. The first substrate 12a and the second substrate 12b are attached together such that an end of the second substrate 12b is aligned with an end of the first substrate 12a in the long-side direction on an end that is opposite to the end on which the terminals and the panel flexible printed board 33 are arranged.

A normally white type switching liquid crystal panel may be used as the liquid crystal panel 12 of the present embodiment. In such a switching liquid crystal panel, if a potential difference between the first transparent electrode 30A and the second transparent electrode 30B and the third transparent electrode for barrier 30C and the fourth transparent electrode 30D is zero, the liquid crystal layer 27 has the maximum light transmissivity, so that the maximum amount of the light passes through over the entire area of the liquid crystal layer 27. In addition, the liquid crystal panel 12 according to the present embodiment, the driving thereof is controlled by supplying a predetermined potential to the electrodes 30A to 30D, and a viewer can view the stereoscopic image if the liquid crystal display device 10 is placed in both of the portrait orientation and the landscape orientation.

Specifically, if the liquid crystal display device 10 is placed in the portrait orientation, a reference potential is supplied to the second transparent electrode 30B, the third transparent electrode 30C, and the fourth transparent electrode 30D, and a predetermined potential different from the reference potential is supplied to the first transparent electrode 30A. This does not generate a potential difference between the second transparent electrode 30B and the third and fourth transparent electrodes 30C and 30D, but a potential difference is generated between the first transparent electrode 30A and the third and fourth transparent electrodes 30C and 30D. Accordingly, as illustrated in FIG. 12, the liquid crystal layer 27 of the liquid crystal panel 12 has the minimum light transmissivity at areas that overlap with the first transparent electrode 30A in a plan view. These areas are the barrier sections BA that blocks light. The liquid crystal layer 27 has the maximum light transmissivity at areas that overlap with the second transparent electrode for barrier 30B. These areas are barrier openings BO that allow light to pass therethrough. The barrier sections BA and the barrier openings BO each have a stripe-like shape that extends in the Y-axis direction and are alternately arranged in the X-axis direction, like the band-like shape portion 30Ab of the first and second transparent electrode 30A and the band-like shape portion 30Bb of the second transparent electrode 30B. Eyes LE, RE of the viewer are aligned in an arrangement direction of the barrier sections BA and the barrier openings BO (the X-axis direction) if the liquid crystal display panel 11 is placed in the portrait orientation. In this state, the driving of the liquid crystal display panel 11 is controlled to alternately display an image for left eye and an image for right eye on the pixels PX arranged in the X-axis direction. According to such driving, the barrier sections BA limit viewing angles of the displayed image for right eye (pixels for right eye RPX) and the displayed image for left eye (pixels for left eye LPX), and the images are separately seen by the right eye RE and the left eye LE through the barrier openings BO. This provides binocular disparity if the liquid crystal display panel 11 is used in the portrait position and enables the viewer to see the stereoscopic image.

In contrast, if the liquid crystal display device 10 is placed in the landscape orientation, a reference potential is supplied to the first transparent electrode 30A, the second transparent electrode 30B, and the fourth transparent electrode 30D, and a predetermined potential different from the reference potential is supplied to the third transparent electrode 30C. This does not generate a potential difference between the first and second transparent electrode 30A and 30B and the fourth transparent electrode 30D, but a potential difference is generated between the first and second transparent electrodes 30A and 30B and the third transparent electrode 30C. Accordingly, as illustrated in FIG. 12, the liquid crystal layer 27 of the liquid crystal panel 12 has the minimum light transmissivity at areas that overlap with the third transparent electrode 30C in a plan view. These areas are the barrier sections BA that block light. The liquid crystal layer 27 has the maximum light transmissivity at areas that overlap with the fourth transparent electrode 30D. These areas are barrier openings BO that allow light to pass therethrough. The barrier sections BA and the barrier openings BO each have a stripe-like shape that extends in the X-axis direction and are alternately arranged in the Y-axis direction, like the band-like shape portions 30Ca of the third transparent electrode 30C and the band-like shape portions 30Da of the fourth transparent electrode 30D. Eyes LE and RE of the viewer are aligned in an arrangement direction of the barrier sections BA and the barrier openings BO (the Y-axis direction bracketed in FIG. 12) if the liquid crystal display panel 11 is placed in the landscape orientation. In this state, the driving of the liquid crystal display panel 11 is controlled to alternately display an image for left eye and an image for right eye on the pixels PX arranged in the Y-axis direction. With such driving, the barrier sections BA limit viewing angles of the displayed image for right eye (pixels for right eye RPX) and the displayed image for left eye (pixels for left eye LPX), and the images are separately seen by the right eye RE and the left eye LE through the barrier openings BO. This provides binocular disparity if the liquid crystal display panel 11 is used in the landscape position and enables the viewer to see the stereoscopic image.

The liquid crystal display device 10 that can display the stereoscopic image if it is placed in either the portrait orientation or the landscape orientation may include a gyro scope, which is not illustrated, to detect the orientation of the liquid crystal display device 10 (whether in the portrait orientation or in the landscape orientation). The driving of the liquid crystal display panel 11 and the liquid crystal panel 12 may be automatically switched between a portrait mode and a landscape mode based on a detection signal. If a flat image is required to be seen by the viewer, a reference potential is applied to all of the electrodes 30A to 30D. This does not generate a potential difference between first and second transparent electrodes 30A and 30B and the third and fourth transparent electrodes 30C and 30D and thus the entire area of the liquid crystal layer 27 has the maximum light transmissivity. That is, liquid crystal panel 12 does not include the barrier sections BA that block light. Accordingly, the image displayed on the pixels PX of the liquid crystal display panel 11 does not have the parallax, so that the viewer sees the flat image (the 2D image, the two-dimensional image). No potential may be supplied to all of the electrodes 30A to 30D such that no potential difference is generated between the first and second transparent electrodes 30A and 30B and the third and fourth transparent electrodes 30C and 30D.

The spacers 28 are configured to define the distance (the cell thickness, the gap) between the substrates 12a and 12b of the liquid crystal panel 12. Each spacer 28 is made of a synthetic resin having high light transmissivity (almost transparent) such as inorganic material like silica and organic material such like epoxy resin. The spacers 28 each have a spherical shape and elasticity. As illustrated in FIG. 11, the spherical spacers 28 include two types of spacers having different average particle diameters from each other. One type of the spacers 28 is first spacers (main spacers) 34 and the other type of the spacers 28 is second spacers (sub spacers) 35. The average particle diameter of the first spacers 34 is an average particle diameter AD1 and the average particle diameter of the second spacers 35 is an average particle diameter AD2. The average particle diameter AD1 of the first spacers 34 is relatively larger than a normal distance SD between the substrates 12a and 12b. The average particle diameter AD2 of the second spacers 35 is relatively smaller than the normal distance SD between the substrates 12a and 12b. The normal distance SD between the substrates 12a and 12b is a distance (length) between the substrates 12a and 12b in a normal temperature environment (for example, temperature of the environment in a range of 5 to 35° C.) with no external stresses applied to any one of the substrates 12a and 12b. More specifically, the normal distance SD is a distance between the alignment films 31 and 32 on inner surfaces of the substrates 12a and 12b with the liquid crystal layer 27 therebetween. In the normal temperature environment, while the first spacers 34 are sandwiched and elastically deformed by the substrates 12a and 12b, the second spacers 35 are between the substrates 12a and 12b without being deformed. Accordingly, the first spacers 34 define the distance between the substrates 12a and 12b but the second spacers 35 do not define the distance therebetween in the normal temperature environment.

The average particle diameter AD2 of the second spacers 35 is preferably in a range of 80 to 95% of the average particle diameter AD1 of the first spacers 34, and more preferably in a range of 85 to 95%. An external stress applied to at least one of the substrates 12a and 12b keeps deforming the first spacers 34 until the distance between the substrates 12a and 12b decreases to the average particle diameter AD2 of the second spacers 35. If that the average particle diameter AD2 of the second spacers 35 is smaller than 80% of the average particle diameter AD1 of the first diameters 34, the first spacers 34 may be excessively deformed and damaged. As a result, sufficient pressure resistance may not be obtained. On the other hand, if the environment changes from the normal temperature environment to a low temperature environment (for example, temperature of the environment lower than 5° C.), volume shrinkage occurs in each member. Since the liquid crystal layer 27 is made of a material of which thermal expansion ratio is relatively higher than those of the other members (for example, substrates 12a and 12b and spacer 27), the volume shrinkage of the liquid crystal layer 27 is relatively greater than those of other members. If the average particle diameter AD2 of the second spacers 35 is larger than 95% of the average particle diameter AD1 of the first spacers 34, a difference between the average particle diameters AD1 and AD2 is quite small. In this case, if only a slight decrease occurs in the distance between the substrates 12a and 12b according to the volume shrinkage of the liquid crystal layer 27, the second spacers 35 define the distance between the substrates 12a and 12b in addition to the first spacers 34. Accordingly, further decrease in the distance between the substrates 12a and 12b is not caused according to the occurrence of the volume shrinkage in the liquid crystal layer 27. Accordingly, vacuum bubbles may be likely to be generated in the liquid crystal layer 27. However, as described above, with the configuration in which the average particle diameter AD2 of the second spacers 35 is in a range of 80 to 95% of the average particle diameter AD1 of the first spacers 34, low temperature bubbles are less likely to be generated with ensuring sufficient pressure resistance. Furthermore, if the average particle diameter AD2 of the second spacers 35 is in a range of 85 to 95% of the average particle diameter AD1 of the first spacer 34, the above effects can be more surely obtained.

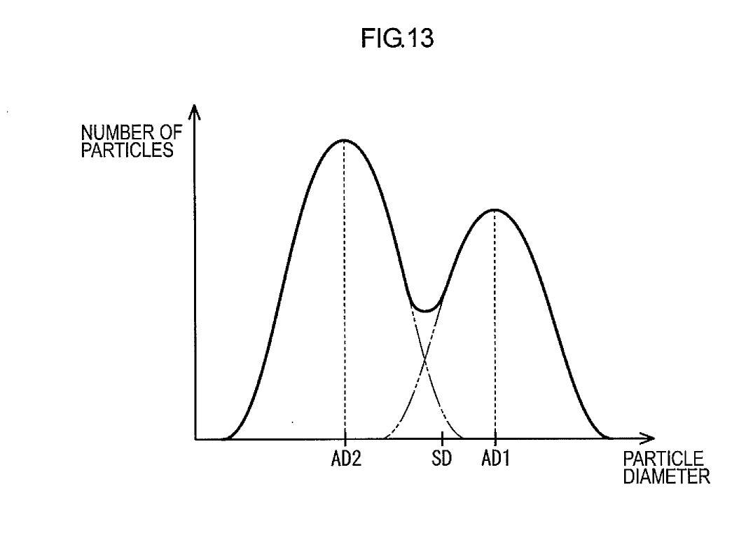

As illustrated in FIG. 13, particle size distributions (particle diameter distributions) of the first spacers 34 and the second spacers 35 are almost in a normal distribution (a bell-shape curve) and dispersion ranges of the particle diameter are substantially equal between the first and the second spacers 34 and 35. Specifically, in the particle size distributions of the first spacers 34 and the second spacers 35, the number of spacers tends to gradually decrease as the particle diameters are distant from the average particle diameters AD1 and AD2, and the number of the spacers tends to gradually increase as the particle diameters are close to the average particle diameters AD1 and AD2. The particle size distribution of the first spacers 34 and the particle size distribution of the second spacers 35 partially overlap with each other. Specifically, a smaller diameter end area in the particle size distribution of the first spacers 34 and a larger diameter end area in the particle distribution of the second spacers 35 overlap with each other in FIG. 13. The overlap area between the particle size distributions of the spacers 34 and 35 is indicated by the two dotted chain line in FIG. 13. The minimum particle diameter in the particle size distribution of the first spacers 34 is relatively smaller than the normal distance SD between the substrates 12a and 12b, that is, the first spacers 34 include some first spacers 34 having particle diameters relatively smaller than the normal distance SD. However, most of the first spacers 34 have diameters relatively larger than the normal distance SD. In similar, the maximum particle diameter in the particle size distribution of the second spacers 35 is relatively larger than the normal distance SD between the substrates 12a and 12b, that is, the second spacers 35 include some second spacers 35 having particle diameters relatively larger than the above normal distance SD. However, most of the second spacers 35 have diameters relatively smaller than normal distance SD. A difference between the minimum particle diameter in the particle size distribution of the first spacers 34 and the normal distance SD of the substrates 12a and 12b is relatively larger than a difference between the maximum particle diameter in the particle size distribution of the second spacers 35 and the normal distance SD of the substrates 12a and 12b.

The number of second spacers 35 is relatively greater than the number of the first spacers 34. Specifically, the second spacers 35 having the average particle diameter AD2 (the number of particles at the peak in FIG. 13) are relatively greater in number than the first spacers 34 having the average particle diameters AD1. With this configuration, the first spacers 34 that are relatively smaller in number than the second spacers 35 tend to be deformed according to the volume shrinkage in the liquid crystal layer 27 in a low temperature environment. Accordingly, the low temperature bubbles are less likely to be generated. In addition, if an external stress is applied to at least one of the substrates 12a, 12b, the second spacers 35 that are greater in number than the first spacers 34 can reduce the possibility of first spacers 34 being excessively deformed and damaged by the external stress. This ensures sufficient pressure resistance. Further, the first spacers 34 are arranged in a sufficient number with a sufficient distribution density to define the normal distance SD between the substrates 12a and 12b in the normal temperature environment without obstructing the following change in the distance between the substrates 12a, 12b caused by the volume shrinkage in the liquid crystal layer 27 in the low temperature environment. The second spacers 35 are arranged in a sufficient number with a sufficient distribution density to resist together with the first spacers 34 against the external stress applied to at least one of the substrates 12a and 12b and to ensure sufficient pressure resistance.

As illustrated in FIG. 11, each second spacer 35 has an adhering layer 36 on an outer surface. The adhering layer 36 is made of a thermoplastic resin and softened and deformed by heat. The heated adhering layer 36 changes its shape and increases a contact area with at least one of the substrates 12a and 12b (the alignment films 31 and 32). In manufacturing of the liquid crystal panel 12, the second spacers 35 are dispersed over one of the substrates 12a and 12b and heated to soften the adhering layers 36 formed on the outer surfaces of the second spacers 35. Then, the adhering layers 36 are adhered to one of the substrates 12a and 12a so as not to move. With this configuration, the second spacers 35, each of which has the average diameter AD2 smaller than the normal distance SD between the substrates 12a and 12b, are less likely to unexpectedly move around or gather one another before, while and after the substrates 12a and 12b are attached together. Each adhering layer 36 covers the outer periphery of each second spacer 35. The softening point of the adhering layer 36 is in a range of 40 to 120° C., and more preferably, in a range of 40 to 70° C. to maintain high adhesiveness between the substrates 12a and 12b.

A ratio of the average particle diameter AD1 of the first spacers 34 to the normal distance SD between the substrates 12a and 12b is in a range of, for example, 1.0 to 1.03 normal distance and a ratio of the average diameter AD2 of the second spacers 35 to the normal distance SD between the substrates 12a and 12b is in a range of, for example, 0.86 to 0.94 normal distance.

The present embodiment has the above-described configuration and the operation of the present embodiment will be described. In manufacturing the liquid crystal display device 10, the flexible printed boards 21 and 33 are respectively connected to the liquid crystal display panel 11 and the liquid crystal panel 12, which are separately manufactured. Then the liquid crystal display panel 11 and the liquid crystal panel 12 are attached together with the photo curable adhesive GL therebetween. A method of manufacturing the liquid crystal panel 12 will be described in detail.

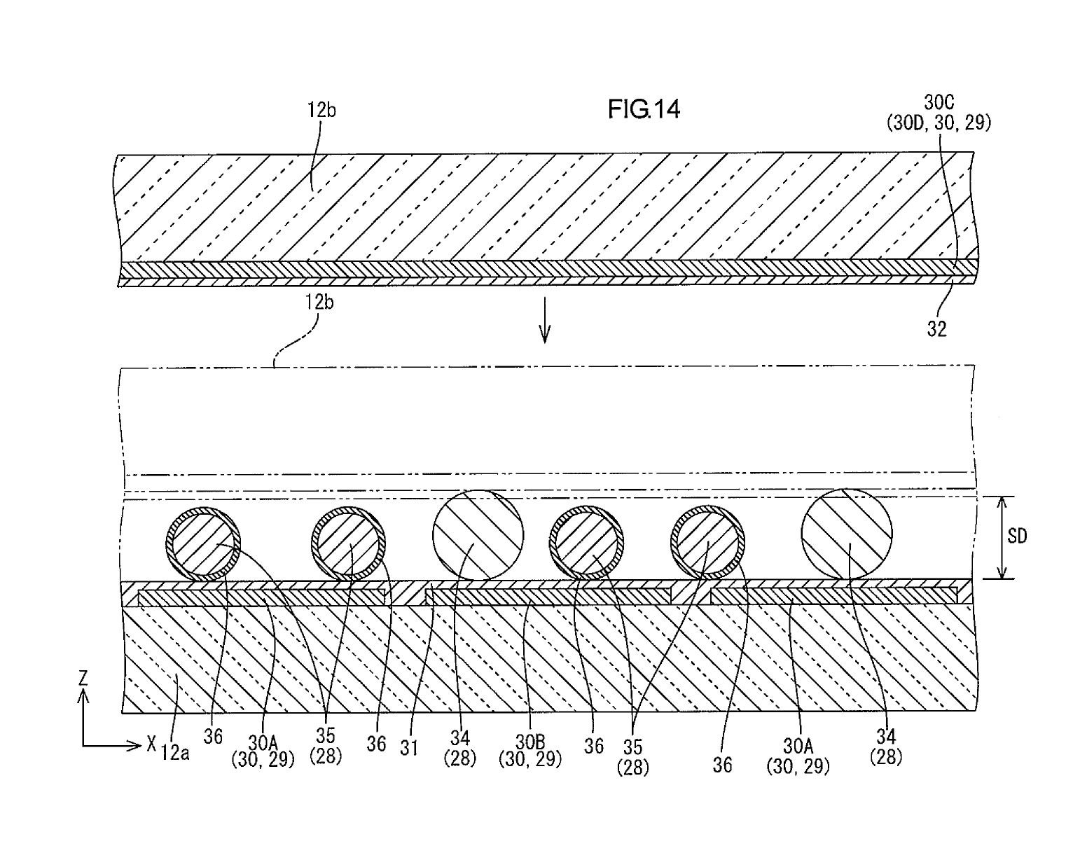

In manufacturing the liquid crystal panel 12, transparent electrodes 30A to 30D are formed on the first substrate 12a and the second substrate 12b by the photolithographic method. Then the alignment films 31 and 32 are provided and alignment treatment is performed. As illustrated in FIG. 14, the predetermined numbers of the spherical spacers 28, that is, the first spacers 34 and the second spacers 35 are dispersedly arranged on, for example, the first substrate 12a. The first spacers 34 and the second spacers 35 illustrated in FIG. 14 are not deformed in this stage. If the first substrate 12a is heated by a heating device, which is not illustrated, the adhering layers 36 on the outer surface of the second spacers 35 are heated and softened. The heated adhering layers 36 change the shape and increase the contact areas with the alignment film 31 of the first substrate 12a. This firmly fixes the second spacers 35 on the first substrate 12a and restricts the movement of the second spacers 35. After that, the frame-like sealant (not illustrated) is applied to surround the arrangement area of the spacers 28 on the first substrate 12a and then the liquid crystals constituting the liquid crystal layer 27 are dripped to an area inside the sealant.

In attaching the substrates 12a and 12b, the second substrate 12b is arranged so as to face the first substrate 12a and moved close to the first substrate 12a. If the distance between the substrates 12a and 12b reaches equal to normal distance SD, the substrates 12a and 12b are attached together by curing a sealant. In FIG. 14, the second substrate 12b after attachment is indicated as the two dotted chain line. Each first spacer 34 has the average diameter AD1 relatively larger than the normal distance SD between the substrates 12a and 12b. Therefore, as illustrated in FIG. 11, according to the attachment, the first spacers 34 are sandwiched by the substrates 12a and 12b and are elastically deformed and pressed to be a flattened shape. The distance between the substrates 12a and 12b are defined by the first spacers 34 and the normal distance SD is stably maintained. The average diameter AD2 of the second spacers 35 is relatively smaller than the normal distance SD between the substrates 12a and 12b. Therefore, the second spacers 35 are located between the substrates 12a and 12b without being deformed. The polarizing plate 12c is attached to an outer plate surface of the second substrate 12b after the attachment of the substrates 12a and 12b. The above manufacturing process of the liquid crystal panel 12 may be suitably changed. For example, the sealant may be applied before the spacers 28 are dispersed.

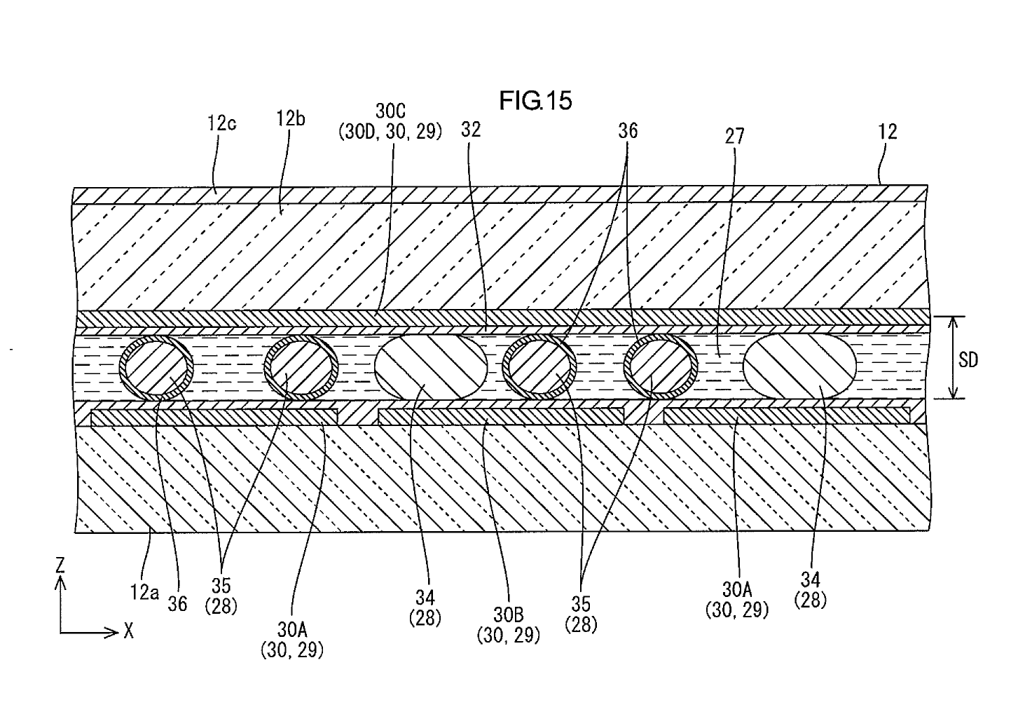

The liquid crystal display device 10 including the liquid crystal panel 12 manufactured as described above may be used in various temperature environments. If the environment is changed from a normal temperature environment to a low temperature environment, volume shrinkage may occur in each component of the liquid crystal panel 12. The liquid crystal layer 27 has an especially high thermal expansion ratio and thus the volume shrinkage thereof is also large accordingly. The liquid crystal layer 27 is surrounded and sealed by the sealant. Therefore, if the volume shrinkage occurs in the liquid crystal layer 27 according to the temperature change, the distance between the substrates 12a and 12b gradually decreases further from the normal distance SD according to the shrinkage as illustrated in FIG. 15. Compared to a case in which the first spacers 34 are in the normal temperature environment, the first spacers 34 are further deformed as the distance between the substrates 12a and 12b deceases. However, the second spacers 35 are hardly deformed until the distance between the substrates 12a and 12b decreases to the average particle diameter AD2 of the second spacers 35. If all of the spacers are configured with the first spacers 34, a force defining the distance between the substrates 12a and 12b will be excessively great and change in the distance between the substrates 12a and 12b cannot follow the volume shrinkage in the liquid crystal layer 27. However, with this configuration, the distance between the substrates 12a and 12b easily decreases according to volume shrinkage of the liquid crystal layer 27, and thus vacuum bubbles are less likely to be generated in the liquid crystal layer 27. In this embodiment, the average particle diameter AD2 of the second spacers 35 is equal to or smaller than 95% of the average particle diameter AD1 of the first spacer 34. Therefore, compared to a case in which the average particle diameter AD2 of the second spacers 35 is larger than 95% of the average particle diameter AD1 of the first spacers 34, a difference between the average particle diameters AD1 and AD2 is sufficiently large in this embodiment. Accordingly, even if the distance between the substrates 12a and 12b decreases according to the volume shrinkage of the liquid crystal layer 27, a sufficient margin is ensured and thus vacuum bubbles are less likely to be generated. The vacuum bubbles may cause unevenness in light transmission of the liquid crystal panel 12. The vacuum bubbles are less likely to be generated and this enhances the quality of a display image in the liquid crystal display panel 11 that is seen by a viewer via the liquid crystal panel 12.

On the other hand, the liquid crystal panel 12 is a member that is arranged on the user (viewer) side relative to the liquid crystal display panel 11 in the liquid crystal display device 10. Therefore, the liquid crystal panel 12 is more likely to receive an external stress. If an external stress is applied to the second substrate 12b on the front side of the pair of the substrates 12a and 12b, the distance between the substrates 12a and 12b decreases smaller than the normal distance SD. This further deforms the first spacers 34 that resist against the stress. If the distance between the substrates 12a and 12b is equal to the average particle diameter AD2 of the second spacers 35, the second spacers 35 in addition to the first spacers 34 are sandwiched by the substrates 12a and 12b and define the distance. With this configuration, the first spacers 34 are less likely to be excessively deformed over the limit of elasticity and less likely to be damaged or broken. This ensures high pressure resistance. In addition, since the average particle diameter AD2 of the second spacers 35 is 80% or larger than the average particle diameter AD1 of the first spacers 34 in the present embodiment, the first spacers 34 are further less likely to be excessively deformed over the limit of elasticity and high pressure resistance is obtained compared to a case in which the average particle diameter AD2 of the second spacers 35 is smaller than 80% of the average particle diameter AD1 of the first spacers 34. FIG. 15 illustrates a state in which the distance between the substrates 12a and 12b is slightly smaller than the average particle diameter AD2 of the second spacers 35 and the second spacers 35 is slightly pressed and elastically deformed.

As described above, the liquid crystal panel (a liquid crystal element) 12 includes a pair of substrates 12a and 12b, the liquid crystal layer 27 arranged between the substrates 12a and 12b, the first spacers 34, and the second spacers 35. The first spacers 34 have the average particle diameter AD1 that is larger than the normal distance SD between the substrates 12a and 12b and are configured to define the distance between the substrates 12a and 12b. The second spacers 35 have the average particle diameter AD2 that is smaller than the normal distance SD between the substrates 12a and 12b and are configured to define the distance between the substrates 12a and 12b.

In this configuration, the average particle diameter AD1 of the first spacers 34 is relatively larger than the normal distance SD between the substrates 12a and 12b. Thus, the first spacer 34 defines the distance between the substrates 12a and 12b with being almost always deformed by the substrates 12a and 12b. The normal distance SD between the substrates 12a and 12b is the distance between the substrates 12a and 12b in a normal temperature environment (for example, temperatures of the environment is in a range of 5 to 35° C.) with no external stresses applied to any one of the substrates 12a and 12b.

In contrast, the average particle diameter AD2 of the second spacer 35 is relatively smaller than the normal distance SD between the substrates 12a and 12b. Thus, the second spacers 35 do not define the distance between the substrates 12a and 12b if no external stress is applied to the substrates 12a and 12b in the normal temperature environment. If the environment is changed from the normal temperature environment to the low temperature environment (for example, temperature less than 5° C.) and volume shrinkage occurs in the liquid crystal layer 27, the distance between the substrates 12a and 12b may decrease to be smaller than the normal distance SD. In this case, although the first spacers 34 are further deformed from the shapes in the normal temperature, the second spacers 35 are hardly deformed until the distance between the substrates 12a and 12b reaches the average particle diameter AD2 of the second spacers 35. This allows the distance between the substrates 12a and 12b to decrease easily according to the volume shrinkage in the liquid crystal layer 27 and thus vacuum bubbles are less likely to be generated. If an external stress is applied to at least one of the substrates 12a and 12b in the normal temperature environment, the distance between the substrates 12a and 12b decreases from the normal distance SD and reaches the average particle diameter AD2 of the second spacers 35 and then the second spacers 35 in addition to the first spacers 34 define the distance between the substrates 12a and 12b. Thus, the first spacers 34 are less likely to be damaged or broken by the excessive deformation. As a result, sufficiently high pressure resistance can be obtained. According to the present embodiment, the low temperature bubbles are less likely to be generated with ensuring sufficient pressure resistance.

The average particle diameter AD2 of the second spacer 35 is in a range of 80 to 95% of the average particle diameter AD1 of the first spacers 34. If the average particle diameter AD2 of the second spacers 35 is smaller than 80% of the average particle diameter AD1 of the first spacers 34 and an external stress is applied to at least one of the substrates 12a and 12b, the first spacers 34 are excessively deformed by the external stress. This may easily cause damage or breakage of the first spacers 34 and sufficient pressure resistance may not be ensured. In contrast, if the average particle diameter AD2 of the second spacers 35 is larger than 95% of the average particle diameter AD1 of the first spacers 34 and the difference between the average particle diameters AD1 and AD2 of the first spacers 34 and the second spacers 35 is quite small, the change in the distance between the substrates 12a and 12b hardly follow according to the volume shrinkage of the liquid crystal layer 27 in the low temperature environment. This may result in easily generating low temperature bubbles. However, as described above, the average particle diameter AD2 of the second spacers 35 that is in a range of 80 to 95% of the average particle diameter AD1 of the first spacers 34 is suitable to reduce occurrence of the low temperature bubbles while ensuring pressure resistance.

The second spacers 35 include the adhering layers 36 that are adhered to at least one of the substrates 12a and 12b. Since the average particle diameter AD2 of the second spacers 35 is relatively smaller than the normal distance SD of the substrates 12a and 12b, the second spacers 35 tend to move around compared to the first spacers 34 that are sandwiched and deformed by the substrates 12a and 12b in the normal temperature environment. With the adhering layers 36 formed on the second spacers 35, the second spacers 35 are firmly attached to at least one of the substrates 12a and 12b and less likely to move around and gather one another.

The number of first spacers 34 is smaller than the number of second spacers 35. With this configuration, the distance between the substrates 12a and 12b easily decreases according to the volume shrinkage in the liquid crystal layer 27 compared to a case in which the number of the first spacers 34 is equal to or larger than the number of the second spacers 35. Thus, vacuum bubbles are less likely to be generated. In addition, if an external stress is applied to at least any one of the substrates 12a and 12b, the second spacers 35 that are greater in number than the first spacers 34 properly define the distance between the substrates 12a and 12b. Therefore, the first spacers 34 are less likely to be excessively deformed and less likely to be damaged or broken.

The parallax barrier pattern 29 is arranged on a plate surface of at least one of the substrates 12a and 12b. With this configuration, the image seen by the viewer through the liquid crystal panel 12 is separated by the parallax barrier pattern 29, and thus the viewer can recognize the stereoscopic image.

The parallax barrier pattern 29 includes a pair of transparent electrodes 30 that are arranged on plate surfaces of the substrates 12a and 12b on the liquid crystal layer 27 side so as to face each other. The transparent electrodes 30 are configured to provide the barrier sections BA and the barrier opening BO between the barrier sections BA by controlling a voltage value between transparent electrodes 30. The barrier sections BA are configured to block light and the barrier openings BO are configured to allow light to pass therethrough. With this configuration in which the barrier sections BA and the barrier opening BO are provided, if an image is seen via the liquid crystal display panel 12, the image is seen at a specific viewing angle through the barrier openings BO arranged between the barrier sections BA. This enables the image to be separated by parallax. In addition, the voltage value between the transparent electrodes 30 is controlled to selectively form the barrier sections BA and the barrier openings BO. This enables the switching between the stereoscopic image display and the flat image display.

The liquid crystal display device (a display device) 10 according to the present embodiment includes the above described liquid crystal panel 12 and the liquid crystal display (a display element) panel 11. The liquid crystal display panel 11 is stacked on the liquid crystal panel 12 and configured to display an image. According to the liquid crystal display device 10 of this embodiment, the liquid crystal panel 12 that is stacked on the liquid crystal display panel 11 for displaying an image has both advantages of reducing occurrence of low temperature bubbles and ensuring pressure resistance. Therefore, the liquid crystal display device 10 has high display quality and an enhanced product lifetime.

The liquid crystal panel 12 included in the liquid crystal display device 10 has the parallax barrier pattern 29 that can separate the image displayed on the liquid crystal display panel 11 by parallax. With this configuration, the image displayed on the liquid crystal display panel 11 that is seen by the viewer via the liquid crystal panel 12 is separated by the parallax barrier pattern 29. Thus, the viewer of the display device can recognize the image as the stereoscopic image.

The liquid crystal panel 12 included in the liquid crystal display device 10 is arranged on a side closer to a viewer than the liquid crystal display panel 11 and therefore easily receives an external stress, for example, the liquid crystal panel 12 may be touched by a user. However, the liquid crystal panel 12 is effective with the above configuration because the first spacers 34 and the second spacers 35 that define the distance between the substrates 12a and 12b ensure high pressure resistance.

The liquid crystal display device 10 includes the backlight unit (lighting device) 12 that is configured to apply light to the liquid crystal display panel 11 included in the liquid crystal display device 10. With this configuration, the liquid crystal display panel 11 displays an image using the light from the backlight unit 12.

### Second Embodiment

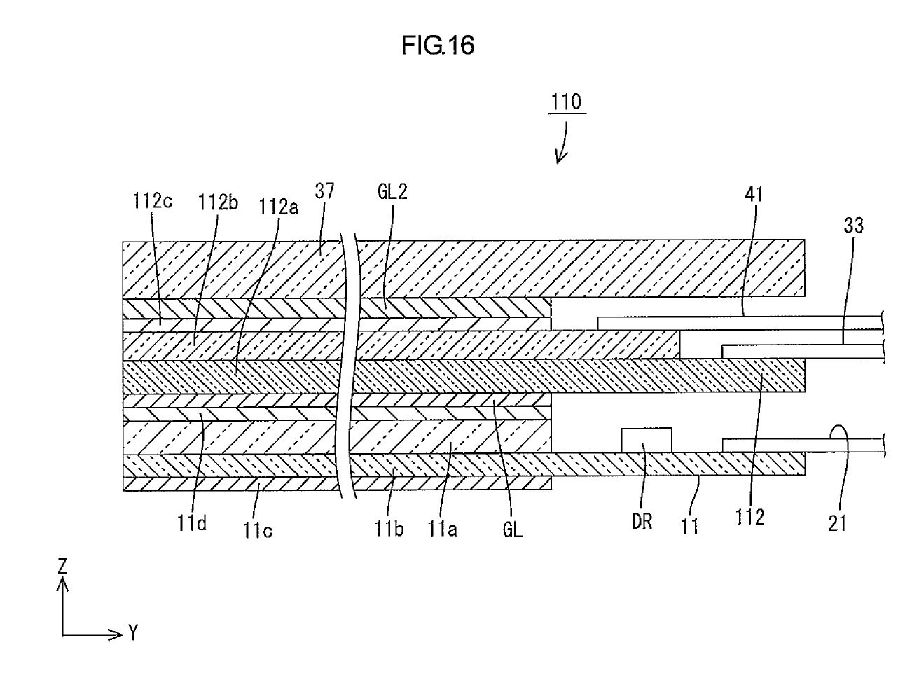

The second embodiment of the present invention will be described with reference to FIG. 16 to FIG. 20. In the second embodiment, a liquid crystal panel 112 has a touch panel function. The construction, operations and effects same as those in the first embodiment will not be explained.

As illustrated in FIG. 16, the liquid crystal panel 112 according to the present embodiment is a multifunctional type of the liquid crystal panel that has the touch panel function (position input function) in addition to the parallax barrier function as described in the first embodiment. A viewer can input positional information in the display surface of the liquid crystal panel 11 by the touch panel function. The liquid crystal panel 112 according to the present embodiment is a “parallax barrier panel” that separates the image to be displayed on the liquid crystal panel 11 by parallax and is a “touch panel (position input panel)” that detects a position input by the viewer. Further, a cover glass (a cover panel) 37 is attached to a front surface side of the liquid crystal panel 112 with an adhesive GL2. The cover glass 37 is made of a transparent glass and configured to protect the liquid crystal panel 112. The cover glass 37 is a member that is directly touched by a user if the touch panel function is used.

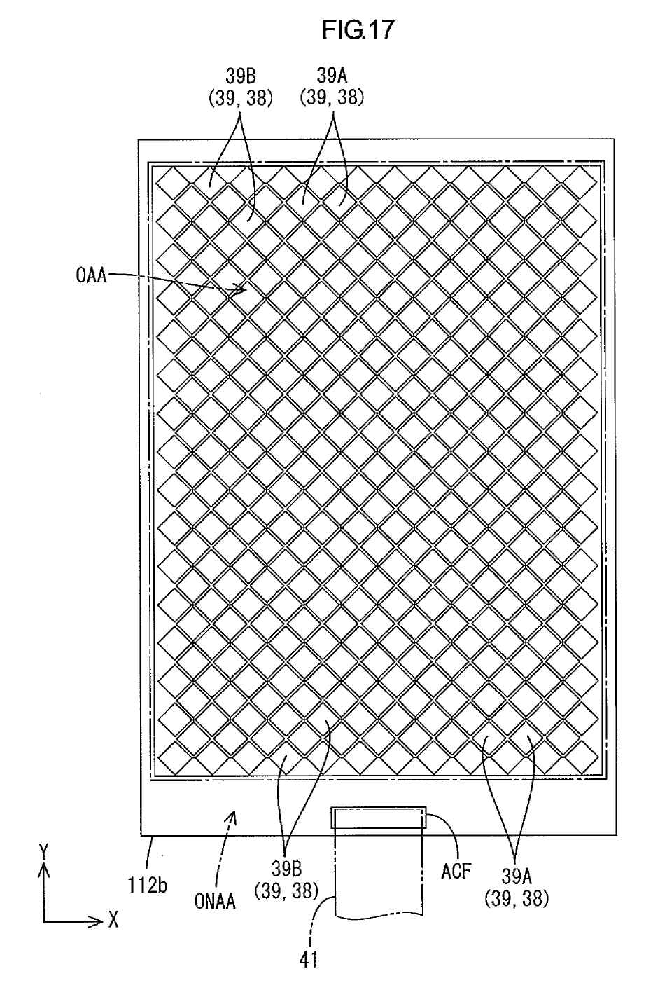

The touch panel function (position input function) of the liquid crystal panel 112 will be described in detail. As illustrated in FIG. 17, the liquid crystal panel 112 includes a pair of substrates 112a and 112b. One substrate in the pair of the substrates 112a and 112b that is arranged on the front side (a user side, a plate surface opposite from the surface on the liquid crystal display panel 11 side) is a second substrate 112b. Transparent electrodes for touch panel 39 are arranged on an outer front surface (a plate surface opposite from the surface on the liquid crystal layer 27 side, a plate surface opposite from the surface on which the transparent electrodes 30 are provided) of the second substrate 112b. The transparent electrodes for touch panel 39 constitute the touch panel pattern of a projected capacitive type. Like the transparent electrodes (transparent electrode for parallax barrier) 30, which constitute the parallax barrier pattern 29 in the first embodiment, the transparent electrode for touch panel 39 is made of a transparent conductive material that is almost transparent, for example, ITO, and arranged in the display overlapping area OAA of the liquid crystal panel 112. With this configuration, the display overlapping area OAA of the liquid crystal panel 112 has the high light transmissivity, and light passed through the display area AA of the liquid crystal display panel 11 can pass therethrough with low loss. The transparent electrodes for touch panel 39 include first transparent electrodes for touch panel 39A that extend in the long-side direction of the second substrate 112b (the Y-axis direction) and second transparent electrodes for touch panel 29B that extend in the short-side direction of the second substrate 112b (the X-axis direction).

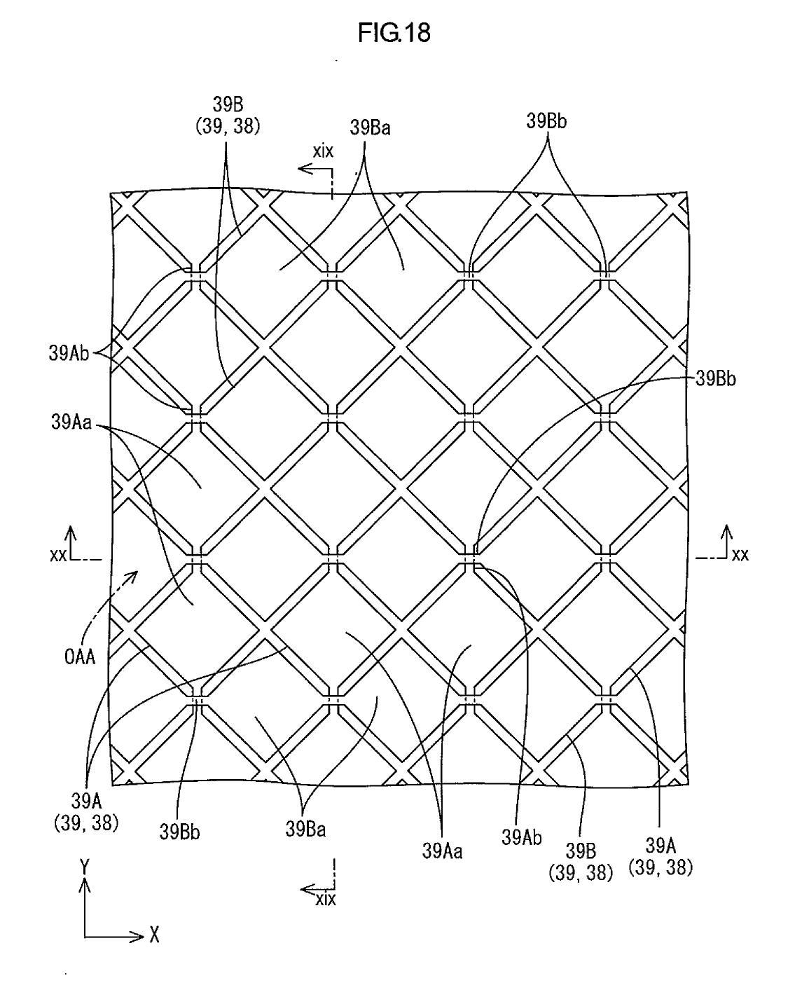

As illustrated in FIG. 18, each first transparent electrode for touch panel 39A includes first electrode pads 39Aa and first connection portions 39Ab. The first electrode pads 39Aa each have a rhomboid shape in a plan view and are arranged along the Y-axis direction. The first connection portions 39Ab connect adjacent first electrode pads 39Aa. The first transparent electrodes for touch panel 39A that extend in the Y-axis direction are arranged in the X-axis direction with a predetermined space therebetween. In contract, each second transparent electrode for touch panel 39B includes second electrode pads 39Ba and second connection portions 39Bb. The second electrode pads 39Ba each have a rhomboid shape in a plan view and are arranged along the X-axis direction. The second connection portions 39Bb connect adjacent second electrode pads 39Ba. The second transparent electrodes for touch panel 39B that extend along the X-axis direction are arranged in the Y-axis direction with a predetermined space therebetween. On the second substrate 112b, the first electrode pads 39Aa constituting the first transparent electrodes for touch panel 39A and the second electrode pads 39Ba constituting the second transparent electrodes for touch panel 39B are respectively arranged in a matrix in the X-axis direction and the Y-axis direction.

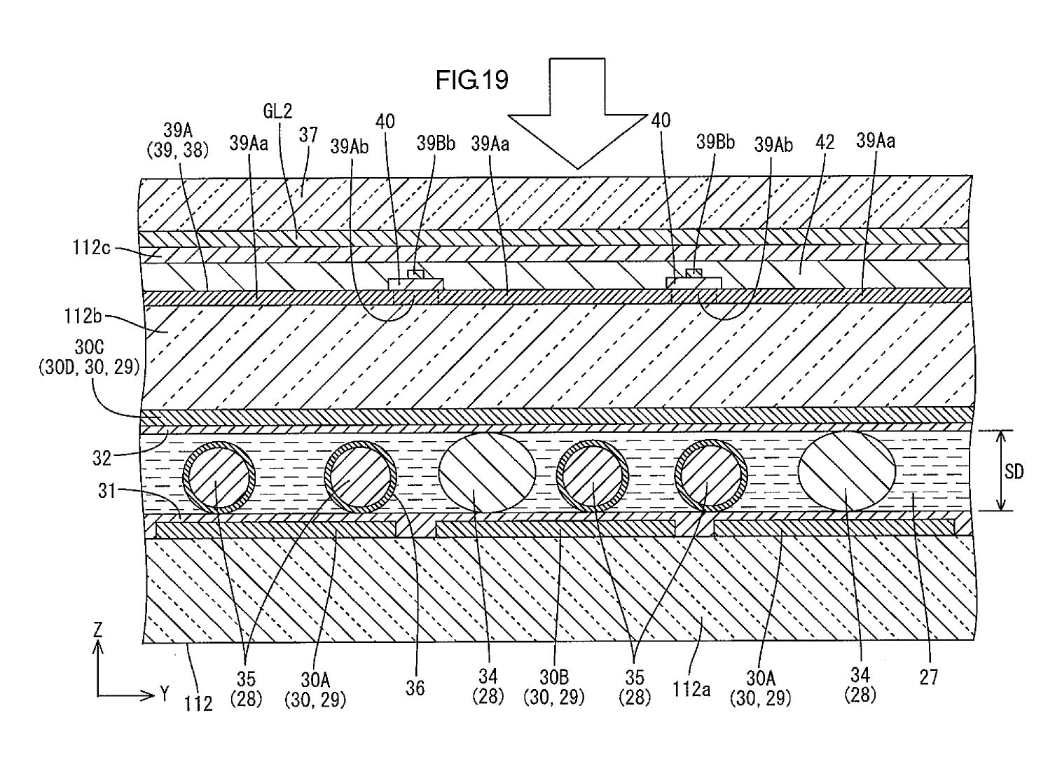

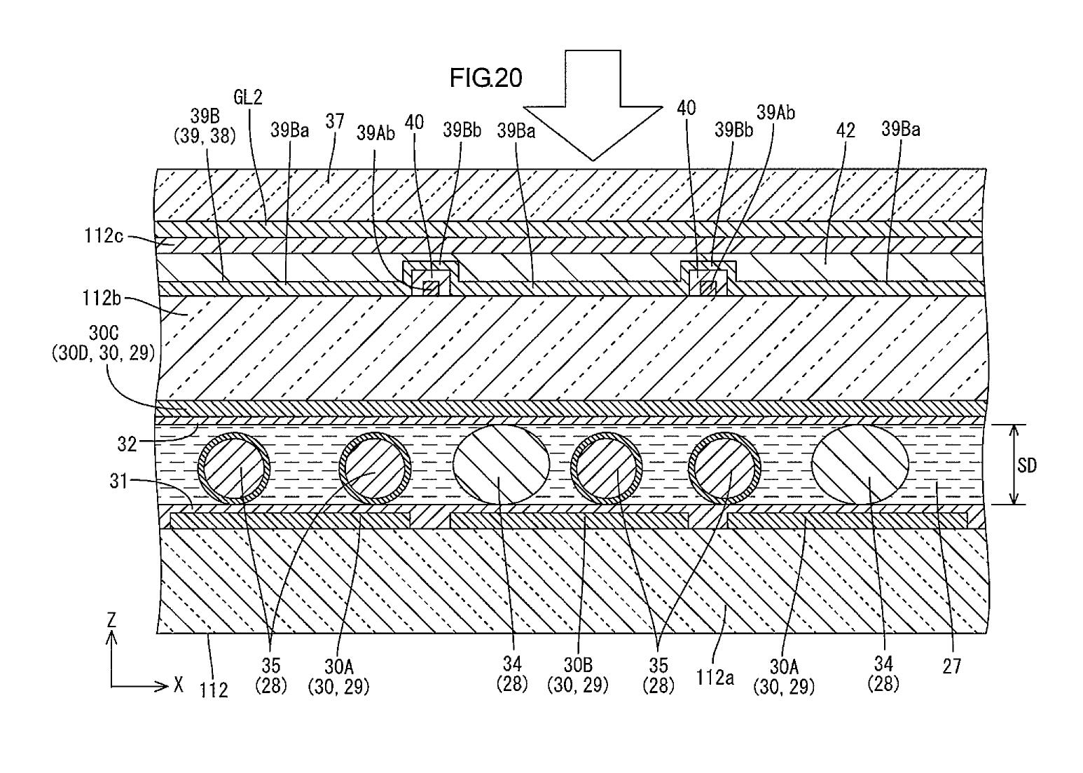

As illustrated in FIG. 19, the first electrode pads 39Aa and the first connection portions 39Ab that constitute the first transparent electrode for touch panel 39A and the second electrode pads 39Ba constituting the second transparent electrode for touch panel 39B are arranged in the same layer on the second substrate 112b. In contrast, as illustrated in FIG. 20, the second connection portions 39Bb that constitute the second transparent electrode for touch panel 39B are arranged above the first connection portions 39Ab with an insulation layer 40 therebetween. With this configuration, short circuit is less likely to occur at an intersection of the first transparent electrode for touch panel 39A and the second transparent electrode for touch panel 39B. A protective layer 42 made of an insulation material is arranged outside the transparent electrodes for touch panel 39A and 39B and the insulation layer 42 so that the protective layer 42 covers and protects the transparent electrodes for touch panel 39A and 39B and the insulation layer 42. A polarizing plate 112c is attached to an outer side of the protective layer 42.

As illustrated in FIG. 17, terminals (not illustrated) extending from the first transparent electrode for touch panel 39A and the second transparent electrode for touch panel 39B are located at an end portion of the second substrate 112b in the long-side direction. One end of a touch panel flexible printed board 41 is connected to the terminals with pressure via an anisotropic conductive film ACF, and the other end of the touch panel flexible printed board 41 is connected to a detecting circuit, which is not illustrated. The terminals and the touch panel flexible printed board 41 are arranged in the display non-overlapping area ONAA of the liquid crystal panel 112. When a user places a finger, which is a conductive body, near an operation screen of the liquid crystal panel 112 or touches the operation screen with the finger while the voltage is applied to the first transparent electrodes for touch panel 39A in rows and the second transparent electrodes for touch panel 39B in rows, the finger of the user and any of the first and second transparent electrodes for touch panel 39A and 39B generate a capacitance therebetween. The generated capacitance at one of the transparent electrodes for touch panel 39A and 39B is different from that of the other transparent electrodes for touch panel 39A and 39B. The detecting circuit determines the transparent electrode for touch panel 39A and 39B that has the capacitance difference, and the coordinate of the intersection between the transparent electrodes for touch panel 39A and 39B is input as two-dimensional (the X-axis direction and the Y-axis direction) location information regarding the operation position of the user. Thus, the liquid crystal panel 112 detects multiple points (multi-touch) at the same time where the user inputs location information on the surface of the operation screen.

In the liquid crystal display device 110 having the above configuration, the cover glass 37 is frequently touched by the user to use the touch panel function. Even if the cover glass 37 protects the second substrate 112b having the touch panel pattern 38 included in the liquid crystal panel 112, the second substrate 112b is frequently affected by the external stresses and such stresses tend to be strong. The liquid crystal panel 112 according to the present embodiment includes the first spacer 34 that has the average particle diameter AD1 relatively larger than the normal distance SD between the substrates 112a and 112b and the second spacer 35 that has the average particle diameter AD2 relatively larger than the normal distance SD between the substrates 112a and 112b. Since the liquid crystal panel 112 has sufficient pressure resistance as described in the first embodiment, those functions (the parallax barrier function and touch panel function) are performed against the frequent and strong stresses, namely, this enhances pressure resistance and product lifetime.

As described above, according to this embodiment, the touch panel pattern 38 is arranged on the plate surface of one of the substrates 112a and 112b. The plate surface faces a side opposite to the liquid crystal layer 27 side. The touch panel pattern 38 is configured to detect a position input by a user. With this configuration, the position touched by the user can be detected by the touch panel pattern 38. The substrates 112a and 112b on which the touch panel pattern 38 is formed frequently receive external stresses and those stresses tend to be strong. However, the liquid crystal panel 112 is effective in the above configuration because the first spacers 34 and the second spacers 35 that define the distance between the substrates 112a and 112b ensure high pressure resistance.

### Other Embodiments

The present invention is not limited to the embodiments explained in the above description with reference to the drawings. The following embodiments may be included in the technical scope of the present invention, for example.

(1) In the above embodiments, the minimum value of the average particle diameter AD1 in the particle size distribution of the first spacers is smaller than the normal distance SD between the pair of the substrates (refer to FIG. 13). However, the minimum particle diameter in the particle size distribution of the first spacers may be larger than or substantially equal to the normal distance SD between the substrates.

(2) In the above embodiments, the maximum value of the average particle diameter AD2 in the particle size distribution of the second spacers is larger than the normal distance SD between the pair of the substrates (refer to FIG. 13). However, the maximum particle diameter in the particle size distribution of the second spacers may be smaller than or substantially equal to the normal distance SD between the substrates.

(3) In the above embodiments, in the particle size distributions of the first spacers and second spacers, the minimum particle diameter of the first spacers is relatively smaller than the maximum particle diameter of the second spacers (refer to FIG. 13). However, the minimum particle diameter of the first spacers may be relatively larger than the maximum particle diameter of the second spacers. In this case, the particle size distribution of the first spacers does not overlap with the particle size distribution of the second spacers. In this configuration, the specific values of the normal distance SD between the substrates are properly determined corresponding to the particle size distribution of the first spacers and the particle size distribution of the second spacers. For example, the normal distance SD may be a value between the minimum particle diameter of the first spacers and the maximum particle diameter of the second spacers or a value larger than the minimum particle diameter of the first spacers (the value should be smaller than the average particle diameter of the first spacer in this case), or a value smaller than the maximum particle diameter of the second spacers (the value should be larger than the average particle diameter of the second spacer in this case).

(4) In the above embodiments, the average particle diameter AD2 of the second spacers is in a range of 80 to 95% of the average particle diameter AD1 of the first spacers. However, in the present invention, the average particle diameter of the second spacers may be smaller than 80% of the average particle diameter of the first spacers or larger than 95% of the average particle diameter of the first spacers.

(5) In the above embodiments, the number of the second spacers are relatively larger than the number of the first spacers. However, the number of the first spacers may be substantially equal to or relatively larger than the number of the second spacer.

(6) In the above embodiments, the outer peripheral surfaces of the second spacers are covered by the adhering layers. However, the adhering layers may partially cover the outer peripheral surfaces of the second spacers.

(7) In the above embodiments, only the second spacers include the adhering layers. However, the first spacers may have the adhering layers or none of the first spacers and the second spacers may include the adhering layers.

(8) Other than the above embodiments, the specific aspect of the particle size distribution and the material of each spacer may be suitably changed. For example, the difference between the minimum particle diameter in the particle size distribution of the first spacers and the normal distance SD between the substrates may be relatively smaller than the difference between the maximum particle diameter in the particle size distribution of the second spacers and the normal distance SD between the substrates. Further, the difference between the minimum particle diameter in the particle size distribution of the first spacers and the normal distance SD between the substrates may be substantially equal to the difference between the maximum particle diameter in the particle size distribution of the second spacers and the normal distance SD between the substrates. Other than above, the particle distribution may be modified in various states. For example, an overlapping state of the first and second particle size distributions or the shape (how the particle distributions spread out) of each particle size distribution of each spacer may be variously changed.

(9) In the second embodiment, the protector is the cover glass made of glass. However, the protector made of a synthetic resin may be used.

(10) In the first embodiment, the protector such as the cover glass included in the second embodiment may be used. In such a case, the protector may be made of a synthetic resin as in the above (9).

(11) In the above embodiments, the present invention is applied to the liquid crystal panel having a parallax barrier function. However, the present invention may be applicable to the liquid crystal display panel that is a display element. The present invention may also be applicable to the liquid crystal display device including only a liquid crystal display panel and not including the liquid crystal panel having a parallax barrier function.

(12) In the above (11), the touch panel pattern in the second embodiment may be provided on the outer plate surface of the substrates (the CF substrate, for example) in the liquid crystal display panel.

(13) In the above embodiments, the liquid crystal panel is arranged on the front side relative to the liquid crystal display panel. However, the liquid crystal panel may be arranged on the rear side relative to the liquid crystal display panel.

(14) In the above second embodiment, the projected capacitive type is described as the example type of the touch panel pattern of the liquid crystal panel. Other than the above, the present invention is applicable to a surface capacitive type, a resistive film type, or an electromagnetic induction type touch panel pattern.

(15) In the above embodiments, the liquid crystal display device can display the stereoscopic image when placed in both of the portrait (vertical position) orientation and the landscape (horizontal position) orientation. However, the liquid crystal display device according to the present technology may have a configuration that can display the stereoscopic image only when placed in one of the portrait orientation and the landscape orientation.

(16) The above embodiments use the liquid crystal panel having the function that allows the user to see the stereoscopic image. However, the present invention is applicable to a liquid crystal display device that includes a liquid crystal panel having a multi-view function that allows users at different viewing angles to see different images.

(17) In the above embodiments, the liquid crystal panel is the switching liquid crystal panel that can switch a display mode between the flat image display and the stereoscopic image display. However, the liquid crystal panel that is configured to always have barrier sections and display a stereoscopic image may be used.

(18) Other than the above (17), the liquid crystal panel may be configured to always display a stereoscopic image and may be unable to switch the display mode between to the stereoscopic image display and the flat image display. For example, a mask filter having a specific light blocking pattern may be formed on one of the boards included in the liquid crystal panel.

(19) In the above embodiments, the backlight unit included in the liquid crystal display device is the edge-light type backlight unit. However, the backlight unit may be a direct-type backlight unit.

(20) In the above embodiments, the liquid crystal display device is a transmission type liquid crystal display device including the backlight unit as an external light source. However, the technology may be applied to a reflection type liquid crystal display device configured to display using outside light. In such a case, the liquid crystal display device may not include the backlight unit.

(21) In the above embodiments, the liquid crystal display device includes a display screen having an elongated rectangular shape. However, the liquid crystal display device may include a display screen having a square shape.

(22) In the above embodiments, the TFTs are used as switching components of the liquid crystal display device included in the liquid crystal display device. However, the technology described herein may be applied to liquid crystal display devices including a liquid crystal display panel using switching components other than TFTs (e.g., thin film diodes (TFDs)). Furthermore, the technology may be applied to a liquid crystal display device including a black-and-white liquid crystal display panel other than a liquid crystal display device including a color liquid crystal display panel.

(23) The above embodiments use the liquid crystal display device including the liquid crystal panel as a display panel. However, the technology can be applied to display devices including other types of display panels (such as PDP and an organic EL panel). In such a case, the backlight unit may not be included.

### EXPLANATION OF SYMBOLS

10: liquid crystal display device (display device), 11: liquid crystal display panel (display element), 12: liquid crystal panel (liquid crystal element), 12a: first substrate (substrate), 12b: second substrate (substrate), 13: backlight unit (lighting device), 27: liquid crystal layer, 29: parallax barrier pattern, 30: transparent electrode, 34: first spacer, 35: second spacer, 36: adhering layer, 38: touch panel pattern, AD1, AD2: average particle diameter, BA: barrier section, BO: barrier opening, SD: normal distance.

1. A liquid crystal element comprising:
a pair of substrates having a normal distance therebetween;
a liquid crystal layer arranged between the substrates;
a plurality of first spacers having an average particle diameter larger than the normal distance between the substrates, the first spacers being configured to define a distance between the substrates; and
a plurality of second spacers having an average particle diameter smaller than the normal distance between the substrates, the second spacers being configured to define the distance between the substrates.

2. The liquid crystal element according to claim 1, wherein the average particle diameter of the second spacers is in a range of 80 to 95% of the average particle diameter of the first spacers.

3. The liquid crystal element according to claim 1, wherein each of the second spacers includes an adhering layer configured to be adhered to at least one of the substrates.

4. The liquid crystal element according to claim 1, wherein the first spacers is relatively smaller in number than the second spacers.

5. The liquid crystal element according to claim 1, wherein a parallax barrier pattern is arranged on a plate surface of at least one of the substrates.

6. The liquid crystal element according to claim 5, wherein
the parallax barrier pattern includes a pair of transparent electrodes arranged on a plate surface of each of the substrates so as to face each other, the plate surface of each substrate facing the liquid crystal layer, and
the transparent electrodes are configured to provide a plurality of barrier sections and barrier openings provided between the barrier sections by controlling a voltage value between the transparent electrodes, the barrier sections being configured to block light, the barrier openings being configured to allow the light to pass therethrough.

7. The liquid crystal element according claim 1, further comprising a touch panel pattern arranged on another plate surface of one of the substrates, the other plate surface facing a side opposite to the liquid crystal layer, the touch panel pattern being configured to detect a position input by a user.

8. A display device comprising:
the liquid crystal element according to claim 1; and
a display element arranged so as to be stacked on the liquid crystal element, the display element being configured to display an image.

9. The display device according to claim 8, wherein the liquid crystal element includes a parallax barrier pattern configured to separate an image displayed on the display element by parallax.

10. The display device according to claim 8, wherein the liquid crystal element is arranged on a side closer to a viewer than the display element.

11. The display device according to claim 8, further comprising a lighting device configured to apply light to the display element.
